(19) United States
(12) Patent Application Publication
(10) Pub. No.: US 2025/0002654 A1
(43) Pub. Date: Jan. 2, 2025

(54) METHODS AND APPLICATIONS FOR SYNTHESIS OF CARBAZOLE PHOSPHAZENE BASED POLYMER AND RECOVERY OF VALUABLE METAL ELEMENTS FROM ELECTRONIC WASTE MATERIALS

(71) Applicant: TURKIYE BILIMSEL VE TEKNOLOJIK ARASTIRMA KURUMU, Ankara (TR)

(72) Inventors: Ali Enis SADAK, Kocaeli (TR); Evren CUCU, Kocaeli (TR); Betul ARI ENGIN, Kocaeli (TR); Murat TUNC, Kocaeli (TR); Ramazan ALTUNDAS, Kocaeli (TR)

(73) Assignee: TURKIYE BILIMSEL VE TEKNOLOJIK ARASTIRMA KURUMU, Ankara (TR)

(21) Appl. No.: 18/509,457

(22) Filed: Nov. 15, 2023

(30) Foreign Application Priority Data
Jun. 22, 2023 (TR) 2023/007409

(51) Int. Cl. C08G 79/025; C22B 11/00

(52) U.S. Cl. CPC C08G 79/025; C22B 11/046

(57) ABSTRACT

A synthesis method for carbazole phosphazene based polymer and a method for the recovery of precious metal elements from electronic waste materials are provided. The developed method allows for the efficient and cost-effective synthesis of carbazole phosphazene based polymer in a single step, with high yield and easy purification. In the method for the recovery of precious metal elements from electronic waste materials, a two-step metal leaching process is employed using solutions with different acidity levels, resulting in the high-efficiency recovery of precious metal elements. The carbazole phosphazene based polymer represented by Formula 2 exhibits high selectivity in the adsorption of precious metal elements, particularly gold. Therefore, it can be applied in the recovery of gold and other precious metals from electronic waste materials in the method for the recovery of precious metal elements.

### CROSS REFERENCE TO THE RELATED APPLICATIONS

This application is based upon and claims priority to Turkish Patent Application No. 2023/007409, filed on Jun. 22, 2023, the entire contents of which are incorporated herein by reference.

### TECHNICAL FIELD

The invention pertains to the technical fields of synthetic organic chemistry, polymer chemistry, and hydrometallurgy. The polymer mentioned in the invention is synthesized through a single-step synthetic organic chemistry reaction and belongs to the class of porous hyper-covalent polymers. Furthermore, the separation of specific metals from electronic waste at different levels of acidity and the subsequent adsorption and recovery of valuable metals in the metal mixture solution prepared with the polymer described in the invention are related to the technical field of hydrometallurgy.

### BACKGROUND

The unstoppable advancement in technology seen in mobile phones, computers, and various electronic devices has continually triggered the desire for newer, more advanced, and affordable devices, leading to a significant increase in societal consumption. This surge has resulted in a decrease in the usage lifespan and lifecycle of electronic products, leaving behind a massive electronic waste (e-waste). It is officially documented that in 2019, the e-waste amounted to 53.6 million metric tons (Mt), with only 17.4% being properly collected and recycled. Despite a 1.8 Mt increase in recycled e-waste since 2014, the total e-waste production has risen by 9.2 Mt, indicating that recycling efforts are struggling to keep up with global e-waste growth. Due to slow adoption of collection and recycling, many countries face significant environmental and public health risks, including resource depletion, greenhouse gas emissions, and the release of toxic substances into the environment during informal recycling procedures. Despite 71% of the world's population being covered by e-waste policies, legislation, or regulations with various parameters, even countries with formal e-waste management systems have relatively low collection and recycling rates. Given the available data, it is evident that recycling rates cannot keep up with the rapid increase in the production-consumption cycle of high-tech products. Moreover, the scarcity or limited quantities of valuable metals used in technological products necessitate the recovery of these metals from e-waste using environmentally friendly and cost-effective systems and techniques, achieving the highest possible efficiency. Urban mining is known as the recovery and recycling of valuable metals from electronic waste and is practiced in many countries using various methods. The application of separating and purifying to obtain pure metal is referred to as refining. The recycling of metals from electronic waste is carried out using three different techniques under the main headings of pyrometallurgy and hydrometallurgy: dry refining, wet refining, and biological refining. In the dry refining method conducted within pyrometallurgical processes, the metal and slag mixture formed after the direct incineration of electronic waste at a temperature of 1000° C. or higher is separated based on density differences. Valuable metals targeted to be captured by this method are obtained in solid solutions, while the direct incineration leads to the formation of plastic-derived secondary pollutants and other hazardous substances, causing air pollution. Additionally, the main disadvantages of the dry refining process include the high cost of equipment, substantial energy consumption for reaching high temperatures, and the inability to separate certain metals such as aluminum using this method. On the other hand, wet and biological refining applications under hydrometallurgy are more environmentally friendly and cost-effective compared to pyrometallurgical applications. However, especially in wet refining applications, a major disadvantage of this method is the numerous recycling steps for valuable metals and the leaving of toxic waste solutions by some of the solvents and materials used. The primary drawback in biological refining applications is the difficulty in controlling microbial behavior during the application due to the complexity of the microbial behavior despite theoretically calculable limitless uses, making them usable only under very limited conditions. In wet refining applications, methods such as solid phase extraction, filtration, co-precipitation, cyanide leaching, ion exchange resins, electrochemical treatment, and reverse osmosis are employed for the recovery of gold and other valuable metals from aqueous solutions. Among these refining methods, the adsorption method, which allows the capture of gold even at very low concentrations and is particularly interesting, is becoming more appealing day by day. E-waste contains various metals such as copper, iron, and tin in high quantities, as well as valuable metals like gold, silver, platinum, and palladium, constituting less than 1% by weight. Particularly due to its excellent physical and chemical properties, gold, among these valuable metals, finds widespread use in computers, phones, medical equipment, electronics industry, robotics, aerospace, jewelry, pharmaceuticals, and other industrial fields (HUTCHINGS, Graham. A golden future. Nature Chemistry, 2009, 1.7:584-584.). Gold embedded in e-waste has garnered significant interest in urban mining due to its high market price, being a rare element, and its high economic value. Hence, the development of low-cost, environmentally friendly, and highly efficient recycling methods for gold from e-waste holds great importance. Jadhav and Hocheng have determined the experimental conditions where the highest metal dissolution occurs by altering parameters such as prepared acid and base mixtures, temperature, and stirring speed for metal elements' dissolution in e-wastes (Jadhav, U.; Hocheng, H. Hydrometallurgical recovery of metals from large printed circuit board pieces. Scientific Reports, 2015, 5.1:1-10). In a study conducted by Yavuz and colleagues, a multi-step method was employed to synthesize a porphyrin based porous polymer, which showed high selectivity in the adsorption of precious metal elements, particularly gold (YAVUZ, Cafer Tayyar, et al. Porous porphyrin polymer and method of recovering precious metal elements using the same. U.S. Pat. No. 10,961,343, 2021.). In the same study, the synthesized polymer, with modifications on the solvent systems developed by Jadhav and Hocheng, was successfully utilized in the recovery of gold and valuable metals from electronic waste leachates or river and seawater (JADHAV, U.; HOCHENG, H. Hydrometallurgical recovery of metals from large printed circuit board pieces. Scientific Reports, 2015, 5.1:1-10). In a study conducted in 2023 by Sadak and colleagues, a microporous hyper-crosslinked conjugated polymer named EBE-06 was synthesized by modifying cyclotriphosphazene and tricarbazole, and the structural and gas storage properties of the polymer were investigated for Carbon Capture, Utilization, and Storage (CCUS) (Sadak, A. E., Cucu, E., Hamur, B., Ün, İ., & Altundas, R. (2023). Cyclotriphosphazene and tricarbazole based microporous hyper-crosslinked conjugated polymer for carbon capture, utilization and storage (CCUS): Exceptional CO₂ selectivity and high capacity CO₂, CH₄, and H₂ capture. Journal of CO₂ Utilization, 67, 102304). This publication, not directly related to the topic discussed in this study, involves the examination of entirely different features as it aims to prevent carbon dioxide produced by major factories and power plants from reaching the atmosphere and contributing to global warming. Upon reviewing the literature, the metal leaching process is typically achieved by mixing specific concentrations of one or two acid systems and immersing electronic waste into these prepared solution systems in a single-step process to uptake valuable metals into these solutions (JADHAV, U.; HOCHENG, H. Hydrometallurgical recovery of metals from large printed circuit board pieces. Scientific Reports, 2015, 5.1:1-10). When the same solution systems were tested, it was observed that the majority of gold and other valuable elements on electronic waste either were not absorbed into these solution systems or could be absorbed in very low amounts.

What differentiates the subject matter of this patent from previous patents in the related field is primarily the two-step metal leaching process utilizing solutions with different levels of acidity. In the first-stage leaching process, tin-like metals, which are abundant in electronic waste and could adversely affect the adsorption stage, are removed from the electronic waste in the first solution, while the majority of valuable elements, including gold, remain undissolved on the electronic waste. In the second leaching process, almost all of the undissolved valuable elements from the first leaching process are absorbed into the solution. Another point that distinguishes the invention from previous patents and studies is that the synthesized polymer is the first polymer made using carbazole and phosphazene molecules and possesses the ability to selectively capture gold and other valuable metal elements from the metal leachate solutions of electronic waste. Additionally, unlike similar materials in the literature, the synthesized polymer can be synthesized in a single step and with high efficiency, and it can be easily purified. Moreover, the cost of the synthesized polymer is lower than similar materials in the literature, providing an additional advantage for the material.

### SUMMARY

During the leaching process of metals from electronic waste using hydrometallurgical techniques, the current acid mixture systems used often result in a significant portion of valuable metal elements, especially gold, either remaining on the electronic waste or remaining undissolved in the acidic solution. The valuable metals absorbed into the solution are much less than their actual amounts on electronic waste, and due to the high presence of metals like tin and copper compared to the valuable metals in the solution, selectively separating the valuable metals from these metal leachates is a challenging task. Furthermore, polymers developed to selectively capture valuable metals tend to either have high costs or require synthesis in multiple steps. Another crucial aspect from a cost perspective is the high stability of the synthesized polymers for repeated use. One of the aims of the present invention is to provide a method for the selective separation of certain metals on electronic waste through a two-step leaching application on electronic waste to solve the problems mentioned above. Additionally, it describes the synthesis and application of carbazole hexachlorocyclotriphosphazene based porous polymers and derivatives that enable the high selectivity capture and recovery of valuable metals, especially gold, from the solution obtained after the second-stage leaching. Moreover, the obtained polymer can be synthesized in a single step at low cost and high efficiency. Another advantage of the synthesized polymer material is its ability to be used in at least three repeated cycles, enhancing its cost-effectiveness.

### BRIEF DESCRIPTION OF THE DRAWINGS

FIG. 1: FTIR spectra of the carbazole phosphazene based polymer (Formula 2), hexachlorocyclotriphosphazene, and 1,3,5-tri(9H-carbazol-9-yl)benzene.

FIG. 2: Nitrogen adsorption-desorption isotherms of Formula 2 obtained at 77 K.

FIG. 3: Pore size distribution graph of Formula 2.

FIG. 4: XRD pattern of Formula 2.

FIG. 5: Thermal gravimetric analysis (TGA) graphs of Formula 2 showing the change in weight against increasing temperature in air and nitrogen atmospheres.

FIG. 6: Comparative graph showing the results of the metal ion adsorption experiment of Formula 2 and the graph of the 1st standard solution containing a mixture of metal ions.

FIG. 7: Comparative graph showing the results of the metal ion adsorption experiment of Formula 2 and the graph of the 1st part of the 2nd standard solution containing a mixture of metal elements.

FIG. 8: Comparative graph showing the results of the metal ion adsorption experiment of Formula 2 and the graph of the 2nd part of the 2nd standard solution containing a mixture of metal elements.

FIG. 9: Comparative graph showing the results of the metal ion adsorption experiment of Formula 2 and the graph of the 3rd standard solution containing a mixture of metal ions.

FIG. 10: Gold ion adsorption graph of Formula 2 over time at varying pH levels.

FIG. 11: Platinum ion adsorption graph of Formula 2 over time at varying pH levels.

FIG. 12: Silver ion adsorption graph of Formula 2 over time at varying pH levels.

FIG. 13: Palladium ion adsorption graph of Formula 2 over time at varying pH levels.

FIG. 14: Langmuir plot showing the varying adsorption amounts with increasing gold concentration for Formula 2.

FIG. 15: Desorption graph of gold ions adsorbed by Formula 2 in acid solution systems of different ratios over 48 hours.

FIG. 16: Desorption graph of gold ions adsorbed by Formula 2 in acid solution systems of different ratios over 72 hours.

FIG. 17: Graph showing the desorption efficiencies of gold ions adsorbed by Formula 2 over time in acid solution systems with constant HCl and HNO₃ concentrations and varying thiourea concentrations (0.1 M, 0.5 M, and 1.0 M).

FIG. 18: Percentage change graph showing the gold ion adsorption efficiencies in Formula 2 over three repeated adsorption-desorption experiments.

FIG. 19: Graph showing the adsorption experiment efficiencies of gold ions by Formula 2 in the second leaching solution obtained from RAM electronic waste.

FIG. 20: Graph showing the adsorption experiment efficiencies of gold ions by Formula 2 in the second leaching solution obtained from a graphics card electronic waste.

FIG. 21: Graph showing the adsorption experiment efficiencies of gold ions by Formula 2 in the second leaching solution obtained from a motherboard electronic waste.

### DETAILED DESCRIPTION OF THE EMBODIMENTS

In this section, the present invention will be described in more detail with reference to examples provided. These examples are for illustrative purposes only and are not intended to limit the scope of the present invention. The purpose of providing these examples is to make the invention understandable and clear to a person with general knowledge in the art based on the known state of the art.

### Synthesis of Carbazole Phosphazene Based Polymer

The carbazole phosphazene based polymer was prepared in a single-step reaction following the method mentioned in the literature (Sadak, A. E., Cucu, E., Hamur, B., Ün, İ., & Altundas, R. (2023), Cyclotriphosphazene and tricarbazole based microporous hyper-crosslinked conjugated polymer for CCUS: Exceptional CO₂ selectivity and high capacity CO₂, CH₄, and H₂ capture. Journal of CO₂ Utilization, 67, 102304.)

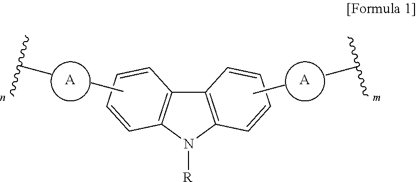

Here, n and m are integers representing the numbers of repeating units, where n is an integer between 1000 and 50000, and m is an integer between 1000 and 50000.

### \textcircled{A}

A, as the linking molecule, can connect carbazoles to each other from any carbon of the benzene groups, positioned among the carbazoles.

R can be any derivative derived from the following cyclic molecules of benzene derivatives containing a varying number of carbazoles, bonded by hydrogen atoms or nitrogen atoms of carbazole:

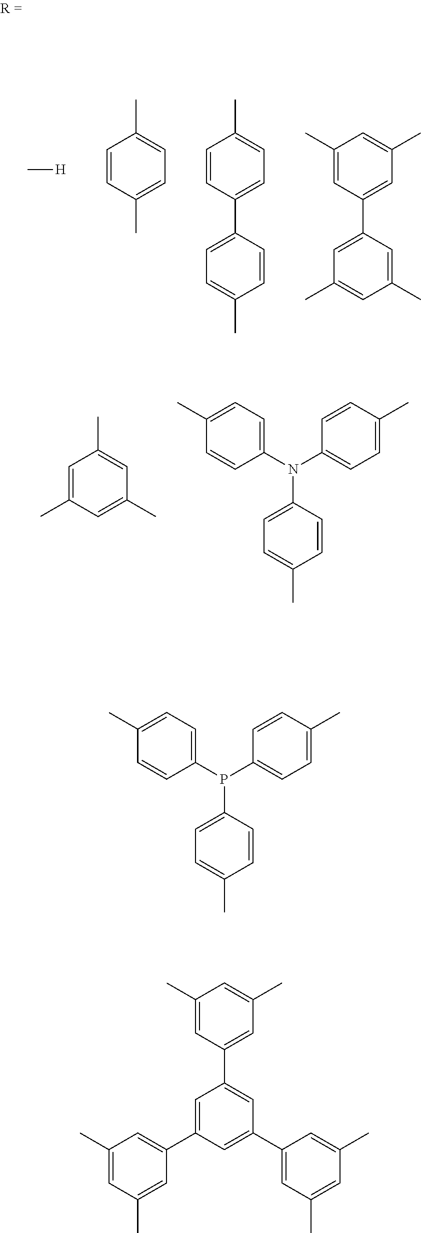

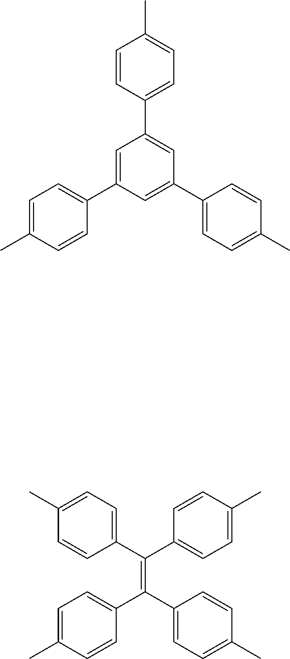

The carbazole phosphazene based polymer represented by Formula 1 can be represented by the following Formula 2:

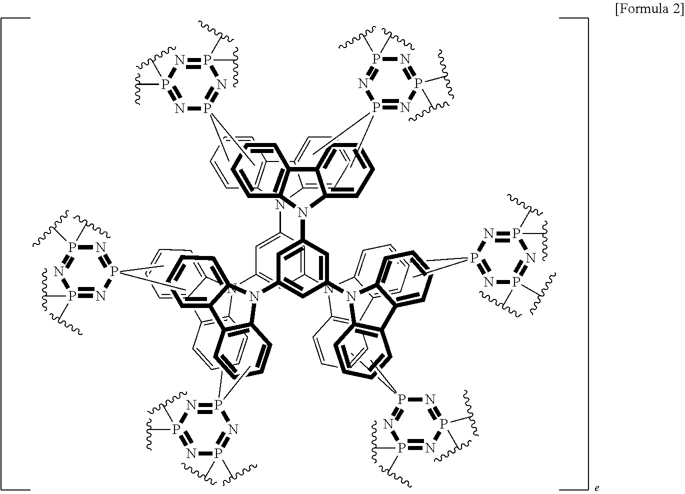

Here, e can be an integer between 1000 and 50000, representing the number of repeating units.

The synthesis of the carbazole phosphazene based polymer involves dissolving 1,3,5-tri(9H-carbazol-9-yl)benzene monomer and hexachlorocyclotriphosphazene monomer in dichlorobenzene, followed by a mixing process. This is further accompanied by a polymerization reaction catalyzed by AlCl₃ or FeCl₃.

The synthesis of the carbazole phosphazene based polymer may involve the following steps:
a) Mixing 1,2-dichlorobenzene and anhydrous AlCl₃ or FeCl₃,
b) Dissolving hexachlorocyclotriphosphazene in 1,2-dichlorobenzene, preferably at room temperature,
c) Mixing the two solutions prepared in steps (a) and (b),
d) Dissolving 1,3,5-tri(9H-carbazol-9-yl)benzene in 1,2-dichlorobenzene,
e) Mixing the solution prepared in step (d) with the solution obtained in step (c), preferably stirring for 4-8 hours, more preferably for 6 hours,
f) Heating and maintaining the mixture at that temperature, preferably heating to 170-210° C., more preferably to 190° C., and maintaining at this temperature preferably for 12-24 hours, more preferably for 18 hours,
g) Cooling the mixture, followed by filtration, preferably at room temperature using a No. 3 glass filter,
h) Washing the filtered solid with acid, preferably HCl; water, preferably distilled water; and alcohol, preferably methanol,
i) Soaking the washed solid in alcohol, preferably methanol, and preferably applying ultrasound, with a soaking time of preferably 20-40 minutes, more preferably 30 minutes,
j) Filtration for separating the solid from the liquid, preferably using a No. 3 glass filter,
k) Purification of the filtered solid with alcohol, preferably methanol, tetrahydrofuran, and acetone using Soxhlet extraction, where the purification step is preferably conducted with Soxhlet extraction for 24 hours,
l) Drying the purified solid, preferably in a vacuum oven at preferably 100-140° C., more preferably at 120° C., for preferably 18-32 hours, more preferably for 24 hours.

In the mentioned synthesis steps, magnetic stirring can preferably be used for mixing processes.

The obtained polymer structure has a BET specific surface area preferably in the range of 250-2200 m²/g and a pore size preferably in the range of 0-30 nm. The characteristic feature of the obtained carbazole phosphazene based polymer is its adsorbent property. When added to solutions containing valuable metal elements, the valuable metal elements adhere to the polymer and can be recovered by desorption from the polymer. The carbazole phosphazene based polymer can be used for the recovery of valuable metal elements from solutions containing valuable metal elements in another application. The method for recycling valuable metal elements from metal solutions containing valuable metal elements comprises the following steps:
(a) Adding the carbazole phosphazene based polymer to the solution containing valuable metals, allowing the valuable metals to adhere to the polymer, and
(b) Involving the desorption and recovery of the valuable metals adsorbed onto the carbazole phosphazene based polymer.

The metal solution containing valuable metal elements can be wastewater from a plating factory or metal solution leaches from electronic waste. The valuable metal elements can be one or more of Au, Pd, Ag, Zr, Pt, Mo, Sc, Re, and Ti, and are not limited to this list. pH values can be adjusted according to the valuable metal elements during the method application. The pH values of the solutions containing valuable metal elements (gold, platinum, silver, and palladium, etc.) to which the carbazole phosphazene based polymer is added can be in the range of 1-10 and preferably 2, 4, 7, or 9. When the valuable metal element is palladium (Pd), the pH of the solution containing the valuable metal element is preferably 2-9, more preferably 7; when the valuable metal element is platinum (Pt), the pH of the solution is preferably 2-9, more preferably 4; when the valuable metal element is gold (Au), the pH of the solution is preferably 2-9, more preferably 2; and when the valuable metal element is silver (Ag), the pH of the solution is preferably 2-9, more preferably 2.

A method for calculating the adsorption efficiency of the carbazole phosphazene based polymer for valuable metal element adsorption can be applied, involving the following steps:
a) Adding the carbazole phosphazene based polymer to standard solutions containing valuable metal elements,
b) Mixing the solution obtained in step (a), preferably using a magnetic stirrer at 80-140 rpm, more preferably at 120 rpm, for 1, 2, 3, 6, 12, 18, and 24 hours,
c) Filtering the solution containing valuable metal elements and carbazole phosphazene based polymer, preferably using a 0.45 μm hydrophobic polytetrafluoroethylene (PTFE) membrane filter,
d) Measuring the metal ion selectivity of the filtered samples, preferably using ICP-MS,
e) Calculating the adsorption efficiency using the obtained measurement values.

The method for recovering valuable metal elements adsorbed by the carbazole phosphazene based polymer may include the following steps:
a) Adding the carbazole phosphazene based polymer to the solution containing valuable metal elements,
b) Mixing the solution obtained in step (a), preferably at 18-25° C., more preferably at 20° C., preferably at 80-140 rpm, more preferably at 120 rpm, and preferably for 36-54 hours, more preferably for 48 hours,
c) Separating the carbazole phosphazene based polymer from the solution by filtration,
d) Washing the filtered carbazole phosphazene based polymer, preferably with pure water,
e) Drying the washed carbazole phosphazene based polymer, preferably in a vacuum oven, preferably at 80-120° C., more preferably at 100° C., preferably for 18-32 hours, more preferably for 24 hours,
f) Mixing the dried valuable metal element-adsorbed carbazole phosphazene based polymer with an acidic solution, preferably with a mixture of 0.05 M thiourea/0.05 M H₂SO₄; 0.1 M thiourea/0.1 M H₂SO₄; 0.5 M thiourea/1 M HCl/1 M HNO₃, or any mixture thereof,

The mixing process is preferably performed by adding 1 mL of the solution per 1 milligram of the polymer, and more preferably at 40-80° C., more preferably at 50-70° C., even more preferably at 60° C., for 1-86 hours, preferably for 1, 3, 6, 12, 24, 36, 48, 54, 72, and 86 hours, more preferably at 80-150 rpm, even more preferably at 120 rpm.
g) Filtration of the solution-polymer mixtures, preferably through a 0.45 μm hydrophobic polytetrafluoroethylene (PTFE) membrane filter,
h) Calculation of desorption efficiency, preferably using ICP-MS.

The carbazole phosphazene based polymer used for the recovery of valuable metal elements from solutions containing valuable metal elements can be reused multiple times. To enable the reuse of the used polymer, a method containing the following steps can be applied:
a) Heating the used carbazole phosphazene based polymer in a basic solution, preferably in a NaOH solution (more preferably in a 2% NaOH solution), preferably for 6 hours,
b) Washing the polymer with deionized water,
c) Drying the polymer at 100° C. in a vacuum oven.

In another application of the invention, the carbazole phosphazene based polymer containing valuable metal elements can be used for the recovery of valuable metal elements from electronic waste materials such as random access memory (RAM), graphics card, and smart card, which contain valuable metal elements. The method for recovering valuable metal elements from electronic waste materials comprises the following steps:
a) Removal of the coating layer from an electronic waste product part using a basic solution,
b) Immersing the electronic waste product with the removed coating layer into an acidic solution at room temperature or below room temperature, allowing specific metals on the electronic waste to be taken into the acidic solution, and filtration of the first metal leaching solution,
c) Immersing the filtered parts in a second acidic solution at room temperature or below room temperature, allowing the valuable metal elements remaining from the first leaching process on the electronic waste to be taken into the acidic solution, and filtration of the second metal leaching solution,
d) Adding carbazole phosphazene based polymer to the solution.

The method for recovering precious metal elements from the mentioned electronic waste materials in step (b) of the method preferably has a molar concentration of the acid solution lower than the molar concentration of the acid solution used in step (c).

The method for recovering precious metal elements from the mentioned electronic waste materials may include the following steps:
a) Removing the coating layer of the electronic waste materials with a basic solution, preferably NaOH solution.
b) Washing the electronic waste materials extracted from the solution, preferably with deionized water.
c) Immersing the washed electronic waste materials in an acidic solution, preferably in an HCl or HNO₃ solution with a molar concentration of 0.5-5 M, more preferably 1-4 M, even more preferably 2-3 M, and stirring, preferably for 36-54 hours, more preferably for 48 hours, at preferably 18-25° C., more preferably at 20° C., and at preferably 120-180 rpm, more preferably at 150 rpm.
d) Removing the electronic waste materials from the solution and filtering the solution, preferably through an 11 μm cellulose filter paper.
e) Adjusting the filtered solution to a basic pH, preferably pH=2, using NaOH or KOH solution and deionized water.
f) ICP-MS measurement.
g) Immersing the electronic waste materials in an acidic solution, preferably in an HCl or HNO₃ solution with a molar concentration of 5-12 M, more preferably 5-10 M, even more preferably 6-9 M, even more preferably 7-9 M, and stirring, preferably for 18-32 hours, more preferably for 24 hours, at preferably 18-25° C., more preferably at 20° C., and at preferably 120-180 rpm, more preferably at 150 rpm.
h) Removing the electronic waste materials from the solution and filtering the solution, preferably through an 11 μm cellulose filter paper.
i) Adjusting the filtered solution to a basic pH, preferably pH 2, using NaOH or KOH solution and deionized water.
j) ICP-MS measurement.
k) Adding a carbazole phosphazene based polymer to the solution.
l) Mixing the solution and the carbazole phosphazene based polymer, preferably at 18-25° C., more preferably at 20° C., and at 80-140 rpm, more preferably at 120 rpm, for 36-54 hours, more preferably for 48 hours.
m) Filtering the solution, preferably through an 11 μm cellulose filter paper, to separate from the polymers.
n) Measuring the remaining metal ion concentrations in the solution using ICP-MS.

The aforementioned precious metal elements may be selected from the group consisting of Au, Pd, Ag, Zr, Pt, Mo, Sc, Re, and Ti, among others, and are not limited to this list. During the steps where pH adjustments are made in the method for recovering precious metal elements from electronic waste materials, the pH can be adjusted based on the precious metal elements intended for recovery, preferably to pH 2-9, more preferably to pH 2. For high-efficiency recovery of the precious metal element palladium (Pd), the pH of the solution can be preferably adjusted to pH 2-9, more preferably to pH 7. For the precious metal element platinum (Pt), the pH of the solution can be preferably adjusted to pH 2-9, more preferably to pH 4. For the precious metal element gold (Au), the pH of the solution can be preferably adjusted to pH 2-9, more preferably to pH 2. For the precious metal element silver (Ag), the pH of the solution can be preferably adjusted to pH 2-9, more preferably to pH 2.

### Example 1. Synthesis of Carbazole Phosphazene Based Polymer from 1,3,5-tri(9H-carbazol-9-yl)benzene and Hexachlorocyclotriphosphazene Monomers

40 mL of anhydrous 1,2-dichlorobenzene was placed in a flask, to which 2.79 g of AlCl₃ (20.92 mmol, 12 equivalents) was added at room temperature. The mixture was stirred for 15 minutes. Then, 606 mg of hexachlorocyclotriphosphazene (1.74 mmol, 1 equivalent) was dissolved in a 15 mL solution of 1,2-dichlorobenzene and added to the mixture. Subsequently, 1.00 g of 1,3,5-tri(9H-carbazol-9-yl)benzene (1.74 mmol, 1 equivalent), dissolved in 20 mL of 1,2-dichlorobenzene, was added to the reaction mixture. The mixture was stirred with a magnetic stirrer at room temperature for 6 hours. After 6 hours, the mixture was heated to 190° C. and stirred with a magnetic stirrer for 18 hours at this temperature. Upon completion of the reaction time, the reaction mixture was cooled to room temperature and filtered through a No. 3 glass filter to remove the solvent. The resulting black solid was successively washed with 200 mL of 2 N HCl, 200 mL of distilled water, and 100 mL of methanol. The solid polymer was transferred to a beaker and subjected to 30 minutes of ultrasonication in 100 mL of methanol. It was then filtered through a No. 3 glass filter. Subsequently, it was purified through successive 24 hour soxhlet extractions with 100 mL of methanol, tetrahydrofuran, and acetone. The final product was dried in a vacuum oven at 120° C. for 24 hours. The carbazole phosphazene based porous polymer was obtained as a light brown solid with a yield of 1.198 g (98%). IR (powder, cm⁻¹): 1590, 1454, 1311, 1214, 1056, 867, 803, 589, 541.

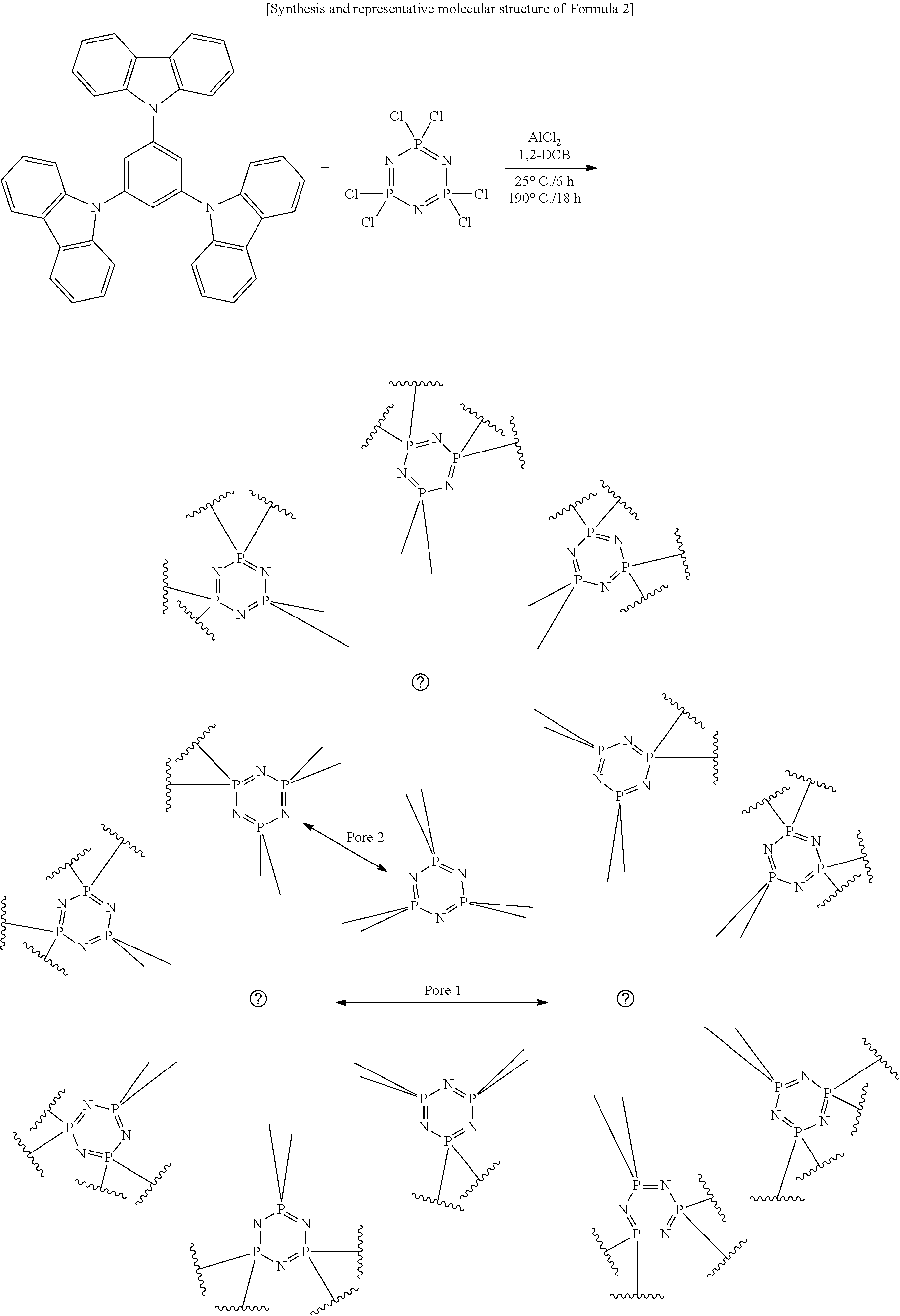

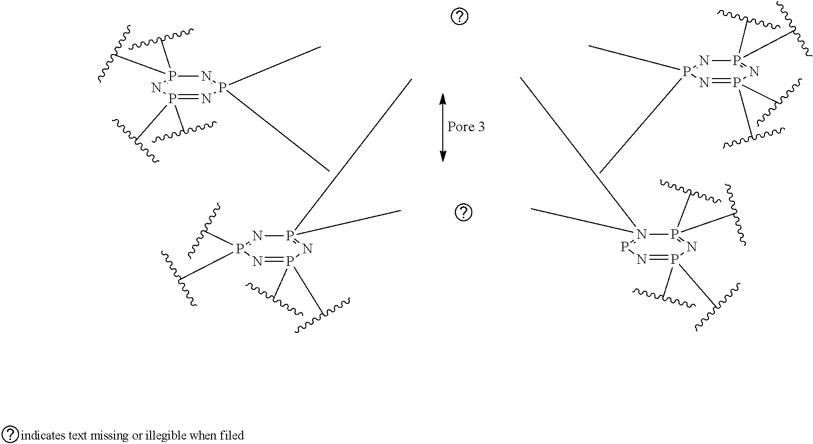

### Example 2: Structural Analysis

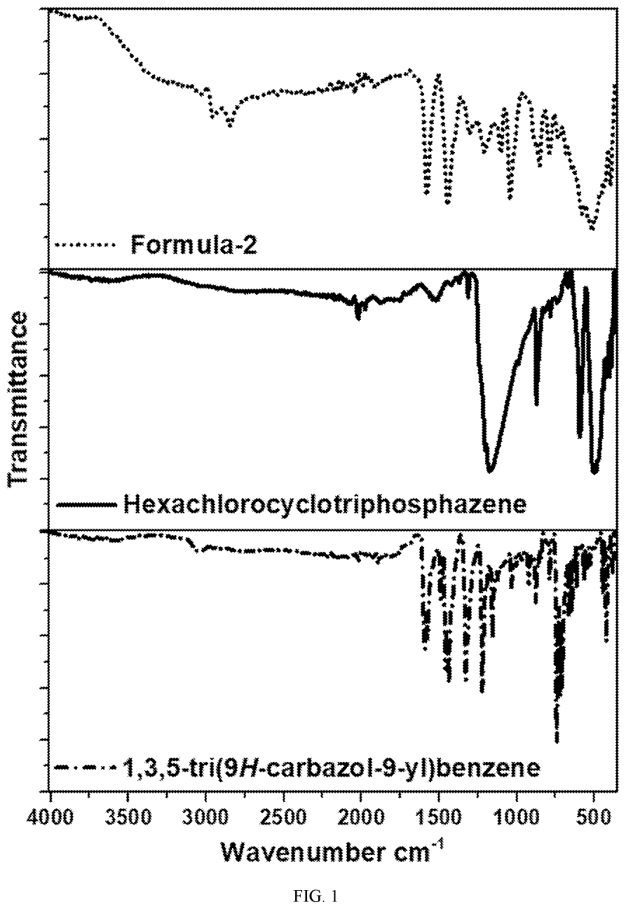

Structural analysis was performed through the comparison of the spectra obtained from Fourier Transform Infrared Spectroscopy (FTIR) measurements of 1,3,5-tri(9H-carbazol-9-yl)benzene, hexachlorocyclotriphosphazene, and the carbazole-phosphazene based polymer obtained from these reagents (Formula 2). The analysis results are shown in FIG. 1. When the FT-IR spectra of 1,3,5-tri(9H-carbazol-9-yl)benzene, hexachlorocyclotriphosphazene, and Formula 2 were comparatively examined, the spectrum belonging to Formula 2 showed a peak at 1056 cm⁻¹, attributed to the P=N−P stretch of the phosphazene ring. The broad peak at 541 cm⁻¹ corresponds to the strong vibrations of the PCI groups that did not participate in the reaction due to high crosslinking. The weak band at 1322 cm⁻¹ and 1322 cm⁻¹ is attributed to the stretching vibrations of C—N—C in the nitrogen of carbazole and carbon atoms of benzene (R. Dawson, T. Ratvijitvech, M. Corker, A. Laybourn, Y. Z. Khimyak, A. I. Cooper and D. J. Adams, Polym. Chem., 2012, 3, 2034-2038.). The peaks at 1595 cm⁻¹ and 1455 cm⁻¹ are characteristic of the stretching of C≡C groups in the cyclic benzene groups of carbazole and C—H groups. Furthermore, the disappearance of signals at 1329 cm⁻¹ and 1222 cm⁻¹ attributed to C—H bending in 1,3,5-tri(9H-carbazol-9-yl)benzene and the appearance of the vibration peak at 1113 cm⁻¹ attributed to the PCP bond at 1113 cm⁻¹ provide evidence for the designed polymer structure.

From the conducted elemental analysis results, it can be inferred that the carbon, nitrogen, and hydrogen content of the obtained polymer (Formula 2) closely align with the theoretically calculated values, further confirming the accuracy of the structure.

TABLE 1

| | Element | | |
|---|---|---|---|
| | C | N | H |
| Calculated (%) | 78.80 | 9.85 | 4.09 |
| Found (%) | 73.19 | 5.85 | 4.50 |

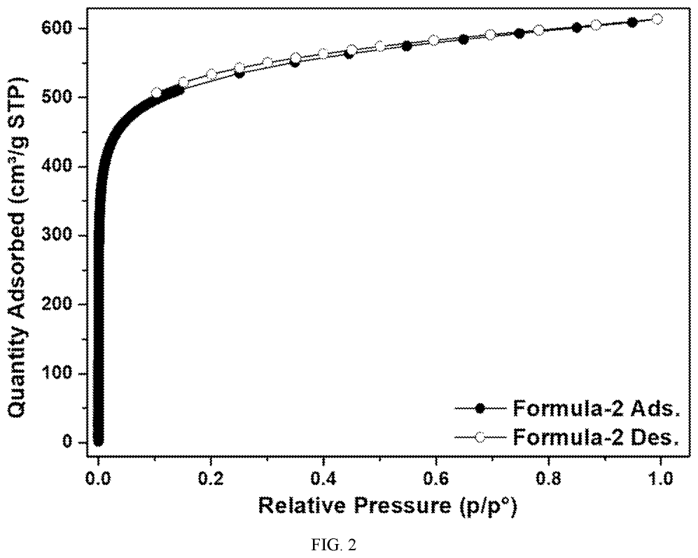

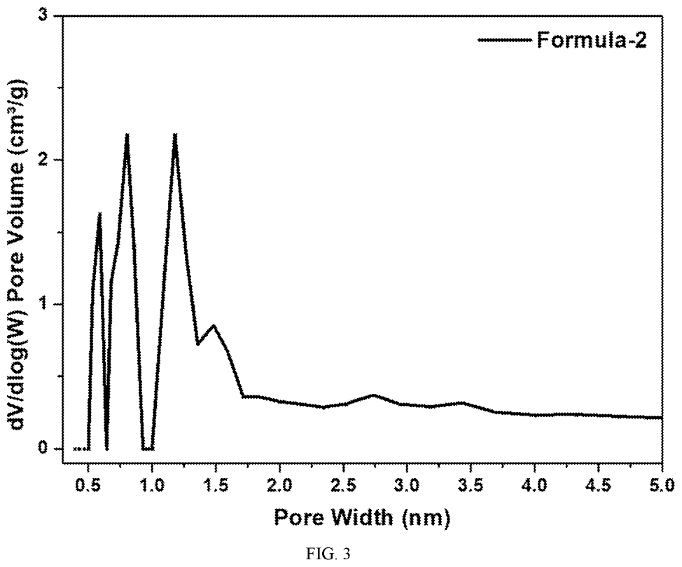

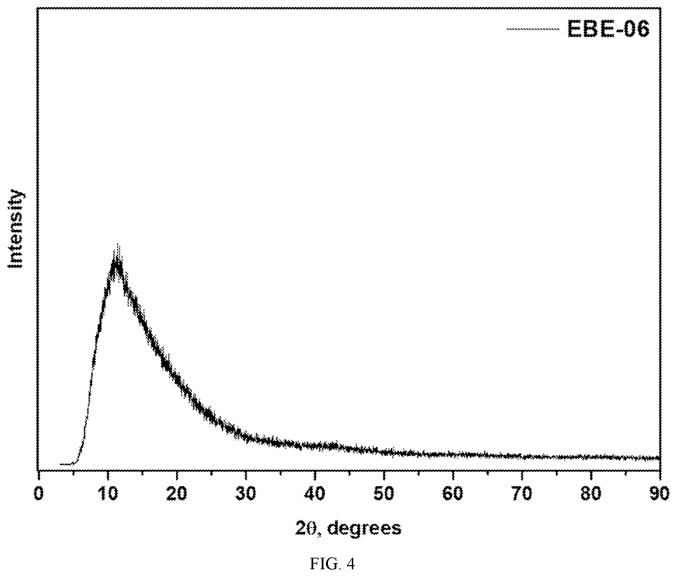

Additionally, nitrogen adsorption and desorption measurements conducted at 77 K are presented in FIG. 2. According to the obtained results, the surface area of Formula 2 was determined to be 1939 m²/g, and based on IUPAC classification, the isotherm graph was identified to be of type I (Sing, K. S. W.; Everett, D. H.; Haul, R. A. W.; Moscou, L.; Pierotti, R. A.; Rouquerol, J.; Siemieniewska, T., Reporting physisorption data for gas/solid systems with special reference to the determination of surface area and porosity (Recommendations 1984). Pure Appl. Chem. 1985, 57, (4), 603-19). FIG. 3 illustrates the pore size distribution characteristics of Formula 2. The dominant observation of three distinct pore sizes in the measured structure at 0.58 nm, 0.80 nm, and 2.17 nm, as expected in the structure resulting from the attachment of a phosphazene structure to 1,3,5-tri(9H-carbazol-9-yl)benzene, indicates that the obtained structure exhibits microporous characteristics and is consistent with the anticipated structure. In FIG. 4, the X-ray diffraction analysis (XRD) results of Formula 2 are presented. As evident from the spectrum, the broad peak around 11° indicates the amorphous nature of the obtained polymer structure.

### Example 3: Thermal Stability Analysis

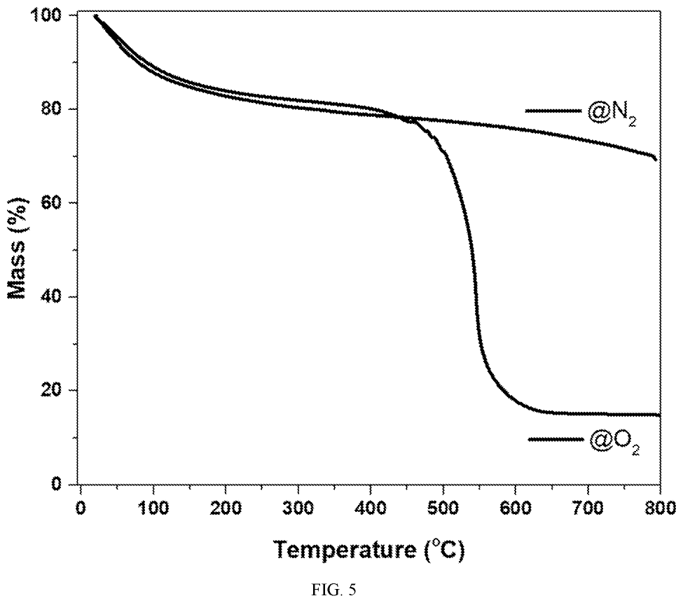

The thermal stability of Formula 2 was measured in air and nitrogen environments using thermogravimetric analysis (TGA) method. The graph shown in FIG. 5 depicts an initial approximately 8% mass loss around 50-100° C., indicating the release of solvent with a low boiling point and water trapped within the polymer. Furthermore, the second mass loss of approximately 7% between 150-185° C. demonstrates the release of 1, 2-dichlorobenzene used as a solvent in the reaction. The obtained results support the nanoporous character of the polymer. The nanoporous structure of Formula 2 hinders the release of solvents trapped in the pores, and these trapped solvent molecules can only be liberated from the polymer at high temperatures. The measurements confirm that Formula 2 is stable up to 400° C. in both air and nitrogen atmospheres.

### Example 4: Metal Selectivity Analysis

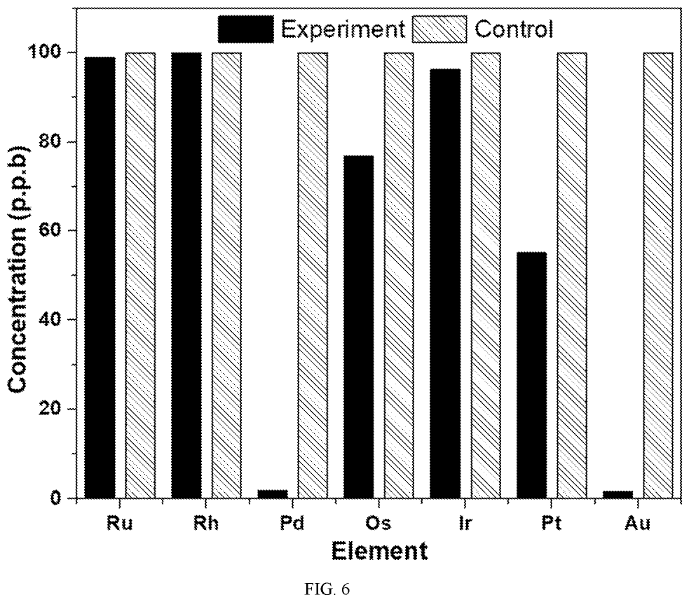

To calculate metal ion selectivity, adsorption experiments were conducted using synthesized Formula 2 with three different standard solutions containing various metal ions. Certified reference solutions containing various metals were used as the inductively coupled plasma-mass spectrometry (ICP-MS) standard solutions. These solutions, containing metals that do not interact and cause precipitation when combined, were diluted from the first standard solution containing 7 elements with a concentration of 10 ppm to the second standard solution containing 48 elements and the third standard solution containing 13 elements. Dilutions were made using deionized water to obtain a calibration curve for ICP analysis. These solutions were further diluted up to 100 fold using deionized water to obtain a 10 point calibration curve. The diluted solutions were divided into three portions for parallel measurements, and each portion was completed to 10 mL with deionized water. To each experimental sample, 10 mg of Formula 2 was added, and the mixture was magnetically stirred at 120 rpm at room temperature for 24 hours. After 24 hours, each sample was filtered using a 0.45 μm hydrophobic membrane polytetrafluoroethylene (PTFE) filter using a 3 mL plastic syringe. The metal concentrations in the filtered samples were measured using the ICP-MS device, and the results shown in FIGS. 6-9 were obtained by taking the average of three parallel measurement results for each sample. The metal ion selectivity of Formula 2 was obtained using the following equation, where Ck represents the average concentration of the control samples, and Cd represents the average concentration of the experimental samples.

$$Adsorption selectivity ( \% ) = \frac{Cd - Ck}{Cd} \times 100 ( \% )$$

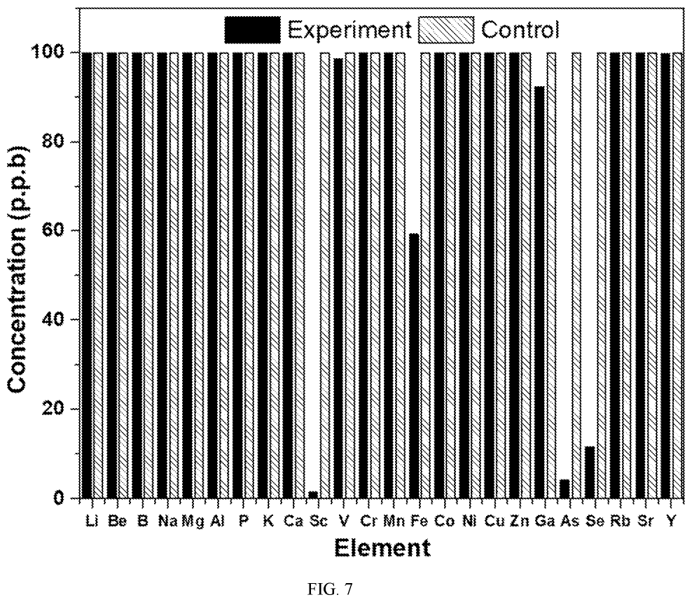

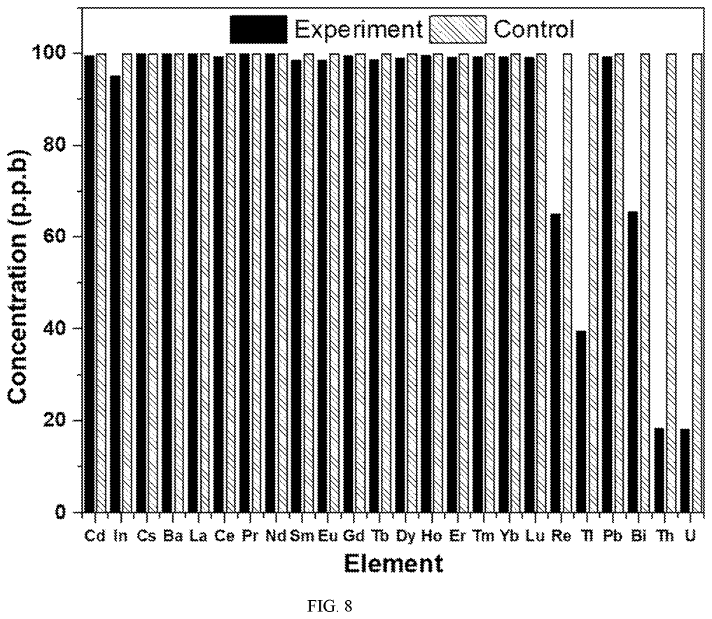

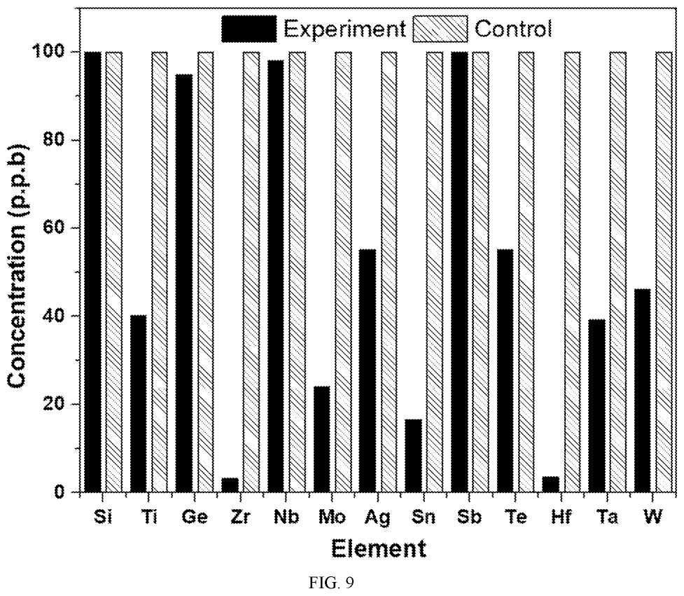

FIG. 6 illustrates the calculated adsorption efficiencies of Formula 2 from the first standard solution as follows: Au (98.47%), Ir (3.71%), Pt (45.00%), Ru (0.99%), Rh (0.00%), Pd (98.18%), and Os (23.18%). Due to standard deviations resulting in a negative value, the experimental average adsorption results (−0.00%) were considered as adsorption for the calculation of adsorption efficiency. As shown in FIG. 7, the calculated adsorption efficiencies of the 1st part metal elements from the second standard solution for Formula 2 are as follows: Li (0.00%), Be (0.00%), B (0.00%), Na (0.00%), Mg (0.00%), Al (0.00%), P (0.00%), K (0.00%), Ca (0.00%), Sc (98.63%), V (1.32%), Cr (0.00%), Mn (0.00%), Fe (40.74%), Co (0.00%), Ni (0.00%), Cu (0.00%), Zn (0.00%), Ga (7.62%), As (95.88%), Se (88.43%), Rb (0.03%), Sr (0.00%), and Y (0.17%). Additionally, in FIG. 8, the calculated adsorption efficiencies of the 2nd part metal elements from the second standard solution for Formula 2 are: Cd (0.61%), In (4.89%), Cs (0.00%), Ba (0.00%), La (0.00%), Ce (0.67%), Pr (0.00%), Nd (0.00%), Sm (1.43%), Eu (1.45%), Gd (0.49%), Tb (1.41%), Dy (1.07%), Ho (0.35%), Er (0.94%), Tm (0.67%), Yb (0.77%), Lu (0.95%), Re (34.99%), Tl (60.48%), Pb (0.75%), Bi (34.46%), Th (81.79%), and U (81.80%). Due to standard deviations resulting in a negative value, the experimental average adsorption results (−0.00%) were considered as adsorption for the calculation of adsorption efficiency. As depicted in FIG. 9, the calculated adsorption efficiencies of Formula 2 from the third standard solution are as follows: Si (0.00%), Ti (59.84%), Ge (5.23%), Zr (96.77%), Nb (1.94%), Mo (76.09%), Ag (44.95%), Sn (83.42%), Sb (0.00%), Te (44.89%), Hf (96.44%), Ta (60.85%), and W (53.93%). Due to standard deviations resulting in a negative value, the experimental average adsorption results (−0.00%) were considered as adsorption for the calculation of adsorption efficiency.

### Example 5: Measurement of the Effect of pH Variation on Adsorption Rate for Gold, Silver, Platinum, and Palladium Ions

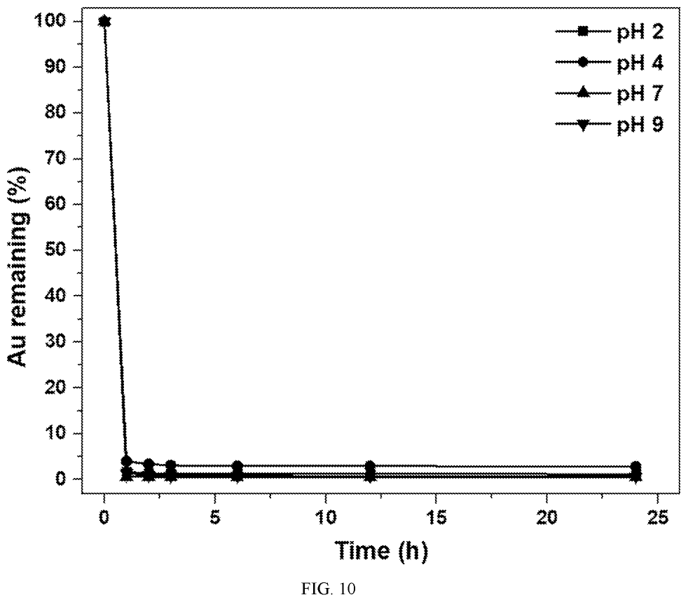

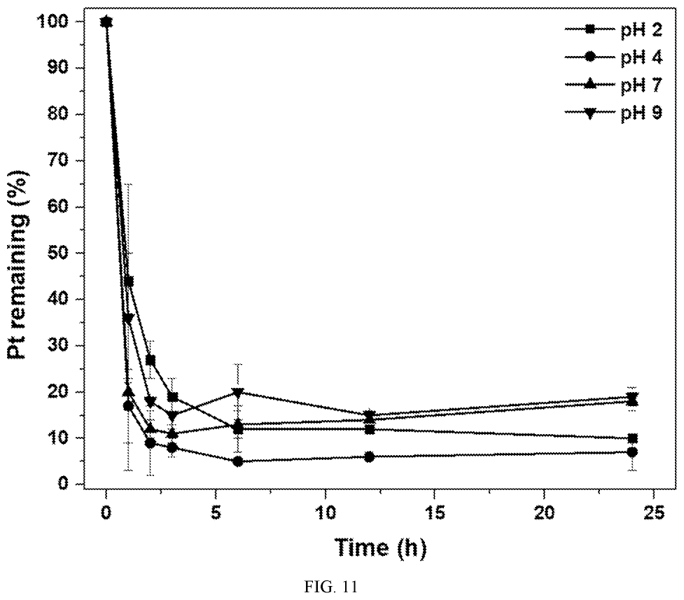

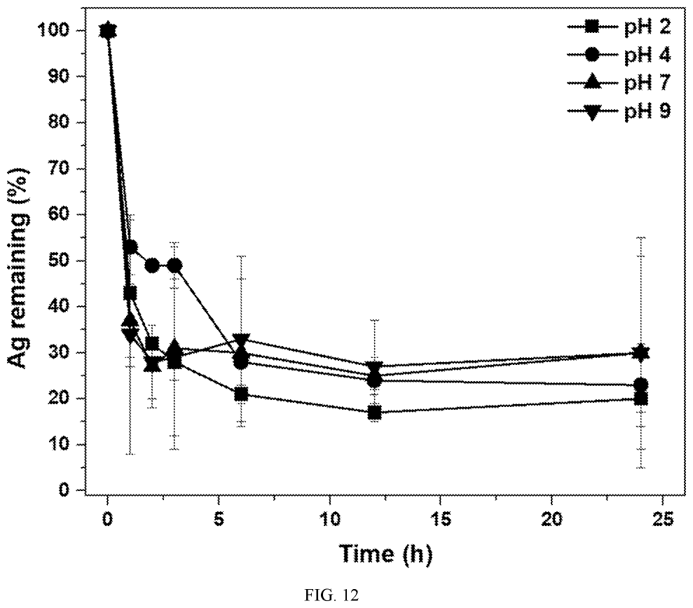

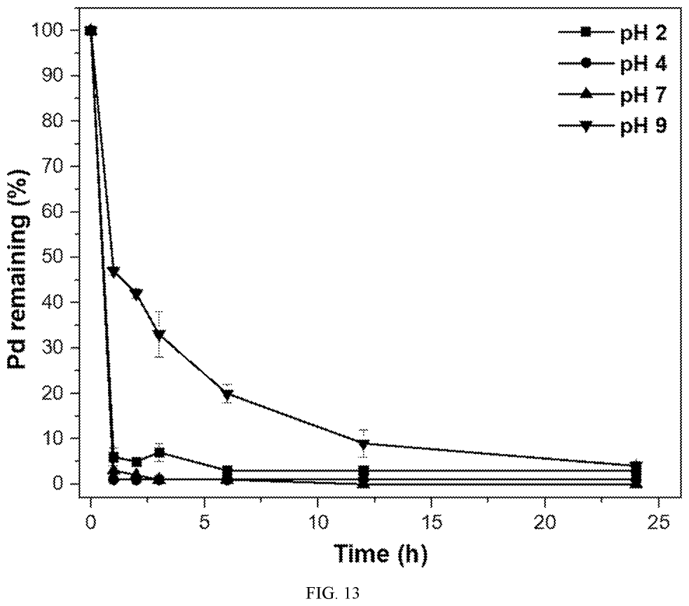

To determine the effect of pH variation on the adsorption rate of Formula 2 in gold, platinum, silver, and palladium ion solutions, aqueous solutions were prepared, each containing approximately 50 ppb of gold, platinum, silver, and palladium ions, with pH values of 2, 4, 7, and 9. Additionally, for calibration purposes, 8 point mixture metal ion solutions ranging from 0.5 ppb to 60 ppb were prepared. Formula 2 (5 mg) was added to each solution with varying pH, each containing 10 mL of metal ion mixture. The concentration of metal ions in each solution was measured using ICP-MS at 1, 2, 3, 6, 12, and 24 hours after the start, and the adsorption efficiency was calculated by comparing it with the initial concentrations. FIGS. 10, 11, 12, and 13 respectively show the experimental results for gold, platinum, silver, and palladium. In FIG. 10, when observing gold ion adsorption with varying pH, it can be seen that there is nearly 100% adsorption at all four different pH values during the 1st hour, indicating that Formula 2 rapidly captures this metal. In FIG. 11, examining platinum ion adsorption with varying pH, it is observed that the highest adsorption value at 1 hour, approximately 83% adsorption, is achieved at pH 4. Furthermore, at the end of 24 hours, approximately 93% platinum ion adsorption is observed again at pH 4. However, at all four tested pH values and at the end of 24 hours, it was determined that Formula 2 has a high adsorption efficiency ranging from 80-93% for platinum ions. In FIG. 12, observing silver ion adsorption with varying pH, it is found that the highest adsorption at 1 hour, approximately 66% adsorption, is achieved at pH 9 among the four different pH ranges where measurements were made. Additionally, at the end of 24 hours, approximately 80% silver ion adsorption is observed at pH 2. In FIG. 13, examining palladium ion adsorption with varying pH, it is found that the highest adsorption at 1 hour, approximately 99% adsorption, is achieved at pH 4 among the four different pH ranges where measurements were made. Additionally, at the end of 24 hours, approximately 100% palladium ion adsorption is observed at pH 7. However, at all four tested pH values and at the end of 24 hours, it was determined that Formula 2 has a high adsorption efficiency ranging from 96-100% for palladium ions.

### Example 6: Measurement of Maximum Adsorption Capacity for Gold Ion

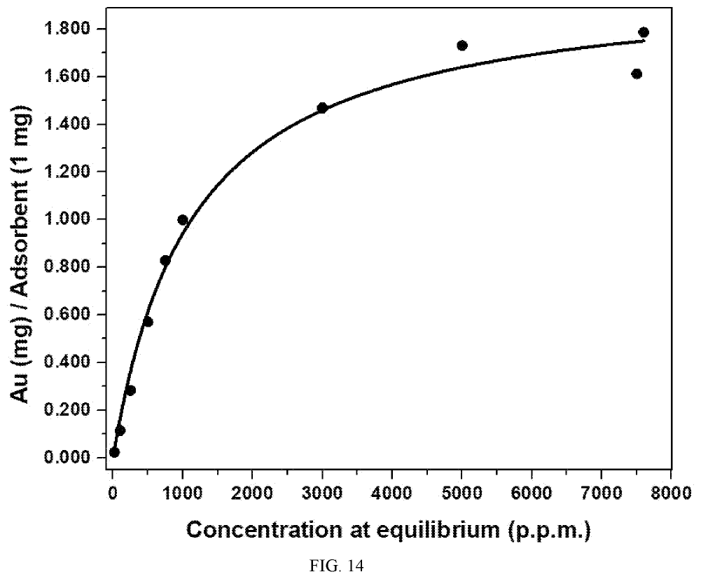

To determine the maximum amount of gold ions that Formula 2 can adsorb per gram, the following experiment was conducted. A 10,000 ppm stock solution of gold (III) chloride trihydrate was prepared using deionized water and kept at +4° C. for 7 days for the solution to stabilize. After 7 days, the real concentration of the solution was determined using ICP-MS after filtration using a 0.45 μm PTFE filter. The prepared gold (III) chloride trihydrate stock solution was diluted to 20, 100, 250, 500, 750, 1000, 3000, 5000, and 7500 ppm solutions, and for each concentration, the solution was divided into portions with 3 parallel measurements for each concentration. Approximately 10 mg of Formula 2 was added to each sample, and the prepared samples were mixed at 120 rpm for 48 hours at 20° C. After 48 hours, each sample was centrifuged at 4500 rpm and then filtered with a 45 μm PTFE filter. The remaining gold ion concentration in the solutions was determined using ICP-MS. The adsorbed gold ion amounts from the obtained measurement results are shown in FIG. 14. From the obtained measurement results, it was found that Formula 2 can adsorb 1.787 mg of gold per milligram.

### Example 7: Recovery of Adsorbed Gold

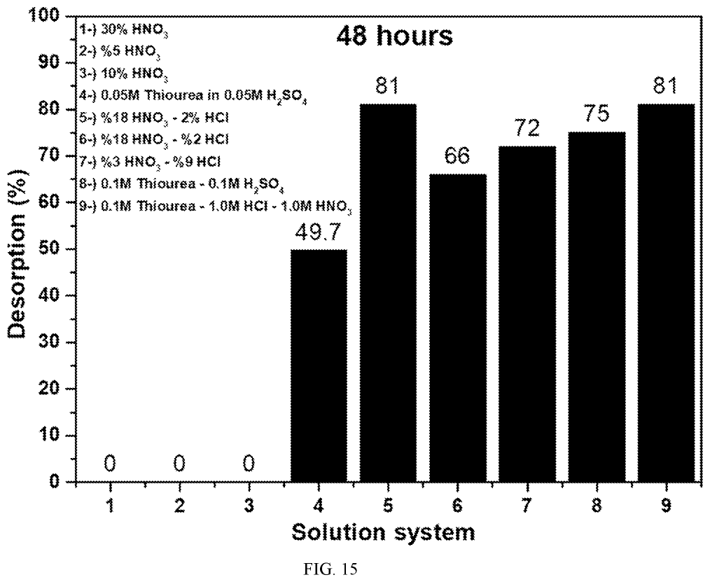

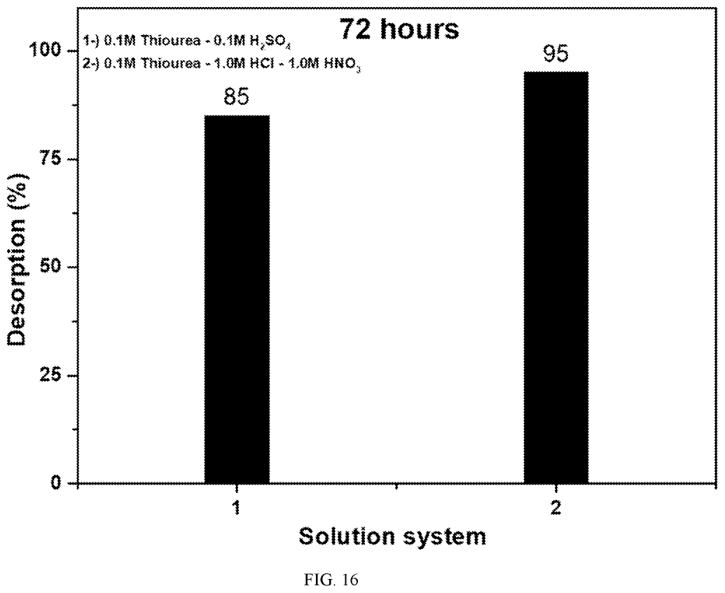

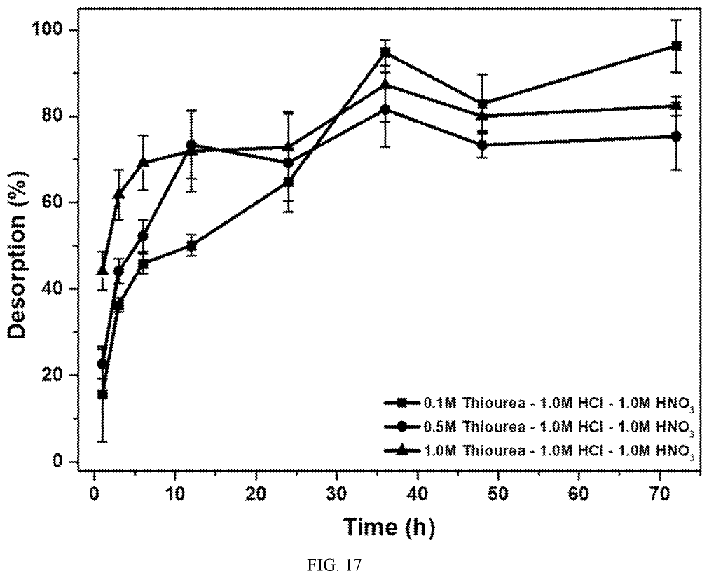

To determine the desorption and recovery conditions of gold adsorbed by the polymer, Formula 2 was added to a saturated gold solution of 735 ppm and mixed at 120 rpm for 48 hours at 20° C. After 48 hours, the polymer, washed with distilled water and filtered through 11 μm filter paper, was left to dry for 24 hours at 100° C. in a vacuum oven. The amount of gold ions adsorbed by the polymer was determined by ICP-MS analysis of the filtered solution. For optimization of the desorption conditions, a three-stage (consisting of three separate experiments) desorption determination method was followed, different from the desorption studies in the literature, for the determination of desorption conditions after gold adsorption by the polymer (YAVUZ, Cafer Tayyar, et al. Porous porphyrin polymer and method of recovering precious metal elements using the same. U.S. Pat. No. 10,961,343, 2021.). Since the desorption experiments in the literature were completed in a total of 48 hours by taking samples at increasing time intervals, all acid mixture combinations for comparison of desorption experiment efficiencies were moved to the second stage based on the 48-hour results. For the first stage of the desorption efficiency determination experiment, for the 8 different solution systems consisting of; % 5 HNO₃; % 10 HNO₃; % 30 HNO₃; 0.05 M thiourea/0.05 M H₂SO₄; % 18 HNO₃/% 2 HCl; % 3 HNO₃/% 9 HCl; 0.1 M thiourea/0.1 M H₂SO₄; 0.1 M thiourea/1.0 M HCl/1.0 M HNO₃, approximately 1-10 mg of gold adsorbed polymer was taken for each experiment, preferably approximately 3 mg, and 3 parallels were taken; for each 1 milligram of the polymer, 1 mL of the solution was added, and the mixtures were mixed at 60° C. for 48 hours at 120 rpm. After 48 hours, the concentration of gold ions desorbed in each experimental sample was determined by ICP-MS. The 48-hour initial desorption experiment results shown in FIG. 15 revealed that the solution mixtures of 0.1 M thiourea/0.1 M H₂SO₄ and 0.1 M thiourea/1.0 M HCl/1.0 M HNO₃ had the highest desorption efficiency. In the second stage, a second 72 hour experiment was conducted for these two experiments. In the second stage, 0.1 M thiourea/0.1 M H₂SO₄ and 0.1 M thiourea/1.0 M HCl/1.0 M HNO₃ solution systems were used again, and the polymer adsorbed with gold was added to these solutions (1 mL of solution for each milligram of polymer), and the prepared solutions were mixed at 60° C. for 72 hours at 120 rpm. After 72 hours, the concentration of gold ions desorbed in each experimental sample was determined by ICP-MS. The results obtained after 72 hours in FIG. 16 showed that the mixture of 0.1 M thiourea/1.0 M HCl/1.0 M HNO₃ had the highest desorption efficiency of approximately 95±6. In the third stage, for the solution mixture of 0.1 M thiourea/1.0 M HCl/1.0 M HNO₃, the thiourea concentration was changed to 0.1 M, 0.5 M, and 1.0 M while keeping the concentrations of HCl and HNO₃ constant. The polymer adsorbed with gold was added to the solution systems of 0.1 M thiourea/1.0 M HCl/1.0 M HNO₃, 0.5 M thiourea/1.0 M HCl/1.0 M HNO₃, and 1.0 M thiourea/1.0 M HCl/1.0 M HNO₃ (1 mL of solution for each milligram of polymer) prepared with constant HCl and HNO₃ concentrations, and the prepared solutions were mixed at 60° C. for 72 hours at 120 rpm, and the desorption efficiencies at 1, 3, 6, 12, 24, 36, 48, and 72 hours were determined by ICP-MS measurements. The results showing the changing desorption efficiency over time in FIG. 17 revealed that the solution mixture of 0.1 M thiourea/1.0 M HCl/1.0 M HNO₃ had the highest desorption efficiency at 72 hours, ranging from 96±6. After the three-stage desorption determination method, it was understood that the highest recovery efficiency for gold adsorbed from the polymer is achieved using a solution of 0.1 M thiourea/1.0 M HCl/1.0 M HNO₃ by mixing the polymer with the solution at 60° C. for 72 hours at 120 rpm.

### Example 8: Determination of Changes in Gold Ion Adsorption Efficiency in Repeated Adsorption-Desorption Experiments

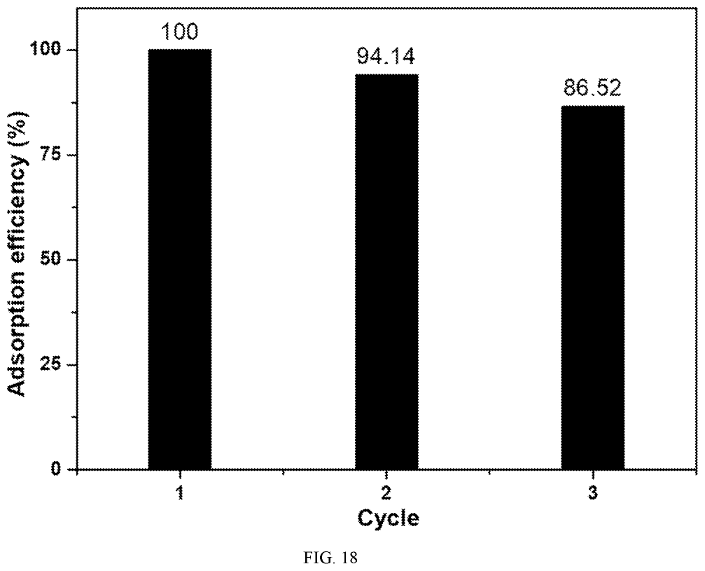

To determine the change in efficiency in repeated adsorption and desorption experiments of the carbazole phosphazene based polymer shown as Formula 2, Formula 2 was added to a 735 ppm gold solution and stirred at 120 rpm for 48 hours at 20° C. At the end of the duration, the remaining gold amount in the solution was measured by ICP-MS, and the amount of gold adsorbed by the polymer was calculated. For the desorption experiment, 1 mL of 0.1 M thiourea/1.0 M HCl/1.0 M HNO₃ solution was added for each 1 mg of gold adsorbed by Formula 2, and the mixture was stirred at 60° C. for 72 hours at 120 rpm. After 72 hours, Formula 2 was separated by filtration through an 11 μm filter paper. The sample taken from the solution was filtered using a 0.45 μm PTFE filter, and the amount of desorbed gold ions in the solution was measured by ICP-MS. Before reusing Formula 2, it was boiled in a Formula 2 solution for 6 hours with 1 mL of 2% NaOH solution for each 1 mg of the polymer. Then, it was washed with 5 mL of deionized water for each 1 mg of the polymer and left to dry at 100° C. in a vacuum oven. According to the results of the cyclic adsorption-desorption experiments repeated three times, shown in FIG. 18, it was determined that Formula 2 had gold ion adsorption efficiencies of approximately 100% in the first cycle, 94.14% in the second cycle, and 86.52% in the third cycle.

### Example 9: Recovery of Valuable Metal Elements from Electronic Waste Products

To demonstrate the applicability of Formula 2 in the real adsorption and recycling of gold ions from electronic waste products, three practical experiments were conducted on printed circuit boards with different amounts of metal content: random-access memory (RAM), graphics card, and motherboard. Although the selected three circuit boards had different amounts of metal content, ICP-MS measurements carried out on the graphics card showed significantly higher amounts of copper (Cu) and tin (Sn) compared to other metals (Table 2). In the selective leaching measurements, the results indicated that the use of a low molar concentration solution in the first stage of leaching may result in many of the gold and other valuable elements remaining in the printed circuit components without dissolving in the solution. After the first leaching process, the remaining parts were separated by filtration, and gold and the remaining valuable metal elements were transferred to the second solution using a more concentrated acidic solution. For the second leaching, acidic solutions with molar concentrations ranging from 5.0 to 12.0 M, composed of HCl, HNO₃, or a mixture of both, can be used.

TABLE 2

| | | Metal |
|---|---|---|
| | | amount |
| No | Metal | (μg/kg) |
| 1 | Na | 22744 |
| 2 | Mg | 21406 |
| 3 | Al | 96583 |
| 4 | Cr | 3306 |
| 5 | Mn | 11813 |
| 6 | Fe | 1610278 |
| 7 | Co | 20758 |
| 8 | Ni | 1584211 |
| 9 | Cu | 38815120 |
| 10 | Zn | 1231819 |
| 11 | Ga | 34 |
| 12 | As | 1317 |
| 13 | Rb | 6 |
| 14 | Sr | 3037 |
| 15 | Y | 7167 |
| 16 | Cd | 11 |
| 17 | Ba | 198495 |
| 18 | Pb | 748737 |
| 19 | Ti | 67340 |
| 20 | Zr | 3401 |
| 21 | Mo | 568 |
| 22 | Ag | 15471 |
| 23 | Sn | 15634751 |
| 24 | Sb | 5935 |
| 25 | Te | 8302 |
| 26 | W | 2561 |
| 27 | Pd | 4102 |
| 28 | Pt | 6 |
| 29 | Au | 1223 |

In the experiment details provided in the tables, a 12.0 M HCl solution was used for the second leaching. After the second leaching, the obtained metal leach mixture was adjusted to the optimal pH of 2 (as shown in FIG. 10) for gold adsorption, along with other valuable elements, using Formula 2. For this purpose, in each experiment conducted, the printed circuit boards, divided into 4 cm×6 cm of four parts in total, were soaked in a 10 M sodium hydroxide (NaOH) solution at room temperature for 24 hours to separate the epoxy coating on the boards. After 24 hours, samples were taken from the sodium hydroxide solution to determine the metal ions transferred to the solution using ICP-MS. After soaking the printed circuit boards in a 10 M NaOH solution for 24 hours, the epoxy layer was removed. During the immersion in a 10 M sodium hydroxide (NaOH) solution, samples were collected from the solution to measure the amount of metal transferred to the solution using ICP-MS for the purpose of determination. The types and quantities of metal ions transferred to the 10 M NaOH solution before the leaching process for RAM, graphics card, and motherboard are shown in Table 3. Parts with the epoxy layer removed, for RAM, graphics card, and motherboard, were immersed in a 1.0 M hydrochloric acid (HCl) solution at a rate of 100 mL per part for a total of 400 mL during the first-stage leaching process. The mixture was agitated in an incubator shaker at 20° C. and 150 rpm for 48 hours. After 48 hours, the printed circuit boards were removed from the solution, and the solution was filtered through 11 μm cellulose filter paper. The pH of the filtered solution was adjusted to pH=2 with a 10 M KOH solution, and then it was filtered through a 1.2 μm membrane filter paper.

TABLE 3
Metal amount (μg/kg)

| | | Graphics | |
|---|---|---|---|
| Metal | RAM | card | Motherboard |
| Li | 0 | 128 | 548 |
| B | 2821 | 26042 | 88525 |
| Na | 0 | 311291875 | 34912 |
| Mg | 2056 | 15991 | 33117 |
| Al | 8558 | 73479 | 372272 |
| P | 311 | 0 | 3448 |
| Ca | 22182 | 113280 | 608253 |
| Cr | 898 | 1758 | 851 |
| Mn | 1770 | 20844 | 17752 |
| Fe | 38200 | 5867457 | 155401 |
| Co | 1037 | 37029 | 17673 |
| Ni | 321400 | 8282432 | 4269739 |
| Cu | 1315439 | 0 | 116629880 |
| Zn | 4877 | 573535 | 18330901 |
| As | 0 | 4522 | 0 |
| Se | 0 | 913646 | 0 |
| Rb | 0 | 205 | 517 |
| Sr | 384 | 2791 | 9793 |
| Y | 895 | 7157 | 13461 |
| In | 120 | 104 | 126 |
| Ba | 64824 | 248360 | 593031 |
| La | 0 | 0 | 116 |
| Ce | 0 | 0 | 268 |
| Nd | 0 | 493 | 0 |
| Sm | 0 | 0 | 118 |
| Eu | 0 | 0 | 264 |
| Gd | 0 | 154 | 676 |
| Dy | 953 | 0 | 1250 |
| Ho | 0 | 0 | 1048 |
| Pb | 60287 | 4453011 | 17449 |
| Bi | 178 | 0 | 196 |
| Si | 985 | 5651 | 3926 |
| Ti | 0 | 328 | 0 |
| Ge | 0 | 1326 | 0 |
| Mo | 0 | 320 | 157 |
| Ag | 196828,1 | 132663 | 1594187 |
| Sn | 0 | 82686 | 958 |
| Pd | 2507 | 1467 | 2530 |

The printed circuit boards were soaked in 1.0 M HCl for 48 hours in the initial leaching process. The acidic solution, after filtration, was diluted to a volume of 1000 mL with a 10 M NaOH solution and deionized water to achieve a pH of 2. It was observed that tin metal precipitated in a white color during this dilution. To determine which metal ions were present in the initial leaching solution and the total metal content, a sample was taken from the solution for measurement by ICP-MS. The types and amounts of metal ions in the initial leaching solution for RAM, graphics card, and motherboard are shown in Table 4.

TABLE 4
Metal amount (μg/kg)

| | | Graphics | |
|---|---|---|---|
| Metal | RAM | card | Motherboard |
| Li | 0 | 128 | 548 |
| B | 2821 | 26042 | 88525 |
| Na | 0 | 311291875 | 34912 |
| Mg | 2056 | 15991 | 33117 |
| Al | 8558 | 73479 | 372272 |
| P | 311 | 0 | 3448 |
| Ca | 22182 | 113280 | 608253 |
| Cr | 898 | 1758 | 851 |
| Mn | 1770 | 20844 | 17752 |
| Fe | 38200 | 5867457 | 155401 |
| Co | 1037 | 37029 | 17673 |
| Ni | 321400 | 8282432 | 4269739 |
| Cu | 1315439 | 0 | 116629880 |
| Zn | 4877 | 573535 | 18330901 |
| As | 0 | 4522 | 0 |
| Se | 0 | 913646 | 0 |
| Rb | 0 | 205 | 517 |
| Sr | 384 | 2791 | 9793 |
| Y | 895 | 7157 | 13461 |
| In | 120 | 104 | 126 |
| Ba | 64824 | 248360 | 593031 |
| La | 0 | 0 | 116 |
| Ce | 0 | 0 | 268 |
| Nd | 0 | 493 | 0 |
| Sm | 0 | 0 | 118 |
| Eu | 0 | 0 | 264 |
| Gd | 0 | 154 | 676 |
| Dy | 953 | 0 | 1250 |
| Ho | 0 | 0 | 1048 |
| Pb | 60287 | 4453011 | 17449 |
| Bi | 178 | 0 | 196 |
| Si | 985 | 5651 | 3926 |
| Ti | 0 | 328 | 0 |
| Ge | 0 | 1326 | 0 |
| Mo | 0 | 320 | 157 |
| Ag | 196828,1 | 132663 | 1594187 |
| Sn | 0 | 82686 | 958 |
| Pd | 2507 | 1467 | 2530 |

The portions of the printed circuit boards taken from the initial leaching solution were immersed in 12 M HCl solution at a rate of 2 mL per gram for 24 hours, using an incubator shaker at 20° C. and 150 rpm. After 24 hours, the printed circuit boards were removed from the solution, and the solution was filtered through an 11 μm cellulose filter paper. Images 1-6 display the printed circuit boards after being kept in 12 M HCl for 24 hours in the second leaching process. The filtered acidic solution was diluted to a volume of 1000 mL with a 10 M NaOH solution and deionized water to achieve a pH of 2. A sample was taken from the solution for measurement by ICP-MS to determine which metal ions were present in the solution and the total metal content. The types and amounts of metal ions in the solution for RAM, graphics card, and motherboard are presented in Table 5.

TABLE 5
Metal amount (μg/kg)

| | | Graphics | |
|---|---|---|---|
| Metal | RAM | Card | Motherboard |
| B | 167 | 1880 | 16031 |
| Na | 0 | 12435077 | 0 |
| Mg | 0 | 1150 | 9615 |
| Al | 0 | 2371 | 108238 |
| P | 0 | 368 | 70065 |
| Ca | 0 | 40588 | 132452 |
| Cr | 131 | 614 | 2833 |
| Mn | 0 | 3753 | 20623 |
| Fe | 490 | 105913 | 69806 |
| Co | 0 | 1014 | 22442 |
| Ni | 120 | 47638 | 1165190 |
| Cu | 196 | 138732 | 55162588 |
| Zn | 0 | 36717 | 1062192 |
| As | 0 | 443 | 0 |
| Rb | 0 | 0 | 1008 |
| Sr | 0 | 31073 | 7605 |
| Y | 0 | 3521 | 4834 |
| Cd | 0 | 475 | 0 |
| Ba | 1527 | 1738723 | 368749 |
| Pr | 0 | 290 | 0 |
| Nd | 0 | 13870 | 0 |
| Sm | 0 | 375 | 0 |
| Eu | 0 | 628 | 207 |
| Gd | 0 | 1609 | 267 |
| Dy | 0 | 0 | 7904 |
| Ho | 0 | 0 | 5052 |
| Er | 0 | 121 | 0 |
| Pb | 0 | 0 | 56373 |
| Bi | 0 | 4879 | 795 |
| Si | 1361 | 6871 | 3285 |
| Ti | 302 | 407474 | 17150 |
| Zr | 0 | 150156 | 0 |
| Nb | 0 | 464 | 0 |
| Mo | 0 | 287 | 0 |
| Ag | 25843 | 33697 | 945665 |
| Sn | 0 | 171437 | 5532 |
| Sb | 0 | 939 | 0 |
| Hf | 0 | 3417 | 0 |
| W | 0 | 331 | 0 |
| Ru | 0 | 0 | 115 |
| Pd | 722 | 6159 | 1345 |
| Pt | 0 | 141 | 0 |
| Au | 389734 | 138638 | 41573 |

### Preparation of the Solution and Adsorption Experiments

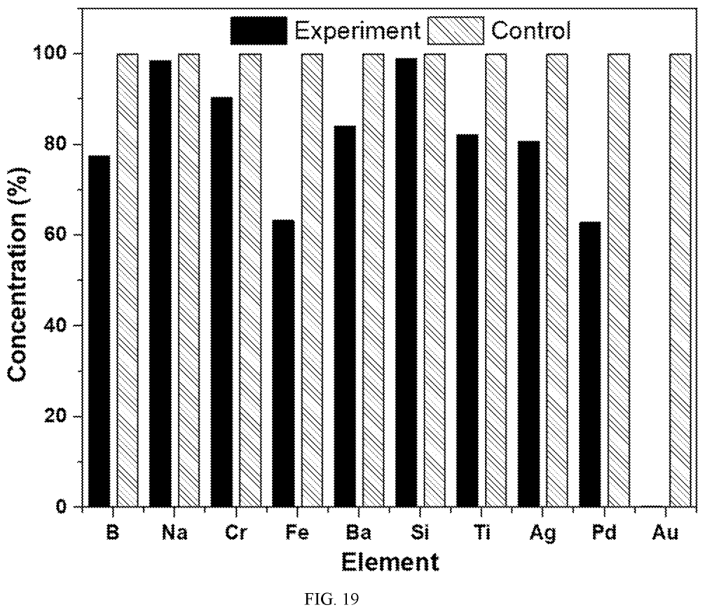

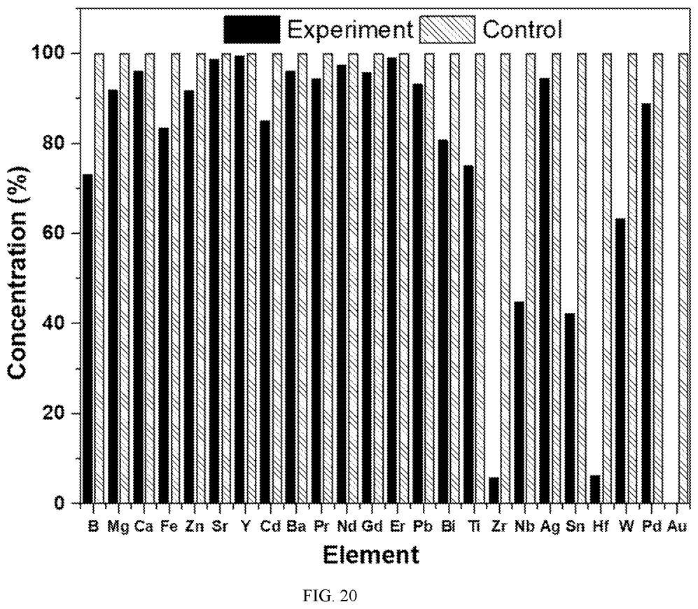

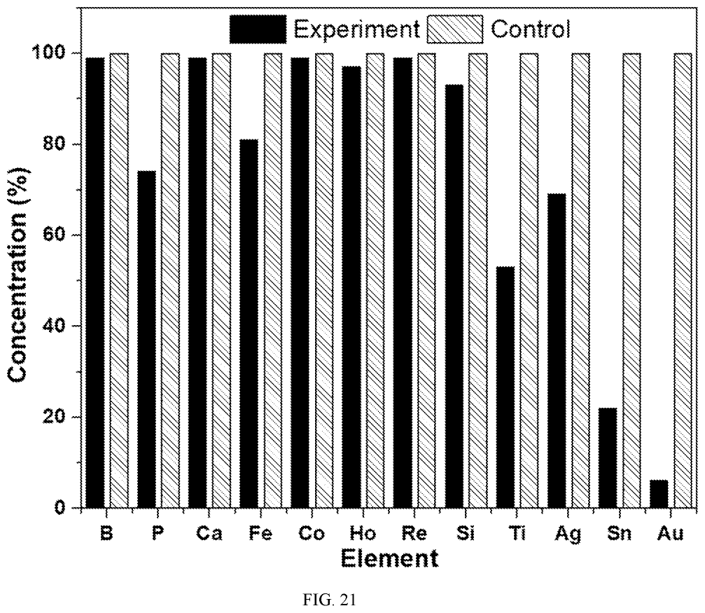

A 250 mL portion of the prepared solution was taken, and 62.5 mg of the porous polymer, denoted as Formula 2, a carbazole phosphazene based polymer, was added to the solution to achieve a ratio of 1 mg of polymer per 4 mL of the solution. The mixture was then stirred at 20° C. and 120 rpm for 48 hours using an incubator shaker. After completion of the duration, the solution was filtered through an 11 μm cellulose filter paper to separate the polymers. The remaining metal ion concentrations in the solution were measured using ICP-MS. FIGS. 19-21 illustrate the comparative adsorption efficiency of Formula 2 for each metal after being added to the second leaching solutions of the printed circuit boards for RAM, graphics card, and motherboard, respectively. The adsorbed concentration as a percentage of the initial concentration of the metal in the solution was compared, assuming a 100% initial concentration. The actual values of metals in the solution mixtures are provided in Tables 4 and 5. Prior to the adsorption experiments, it was determined that the gold ion concentrations in the printed circuit boards were 389 ppm for RAM, 138 ppm for the graphics card, and 41 ppm for the motherboard. According to the results of the experiments performed by adding Formula 2 to the filtered second leaching solutions of the respective printed circuit boards, the polymer exhibited an adsorption efficiency of 99% for gold ions in RAM (FIG. 19). Similarly, the second experiment, involving the addition of Formula 2 to the second leaching solution of the graphics card, showed that the polymer adsorbed 99% of gold ions (FIG. 20). In the third adsorption experiment, which was conducted with electronic waste from the motherboard, it was determined that the polymer adsorbed 94% of gold ions (FIG. 21), despite the relatively low amount of gold ions embedded in the motherboard compared to other metal ions. Particularly in comparison to other metal ions, Formula 2 demonstrated a high selectivity in adsorbing gold ions. These experimental results showed the applicability of Formula 2 in the filtered metal solution leaching of electronic waste.

### APPLICATION OF THE INVENTION IN INDUSTRY

The separation and recycling method performed in the laboratory using the disclosed method and polymer has the potential to be utilized in recycling facilities established for electronic waste. While the present invention has been described in detail based on certain features, it will be understood by those skilled in the art that this specification is merely a preferred arrangement and does not limit the scope of the present invention. Therefore, the scope of the present invention is defined by the claims and their equivalents provided herewith.

What is claimed is:

1. A carbazole phosphazene based polymer, comprising a chemical structure of: 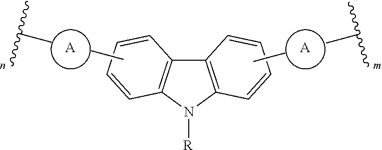
wherein n is an integer between 1000 and 50000 representing a number of first repeating units, and m is an integer between 1000 and 50000 representing a number of second repeating units,
A is a hexachlorocyclotriphosphazene linking molecule for linking carbazoles among benzene groups from a carbon atom,
R is a derivative derived from the following cyclic molecules, being a hydrogen atom or carbazole nitrogen atoms bonded to different numbers of carbazole-containing benzene derivatives:

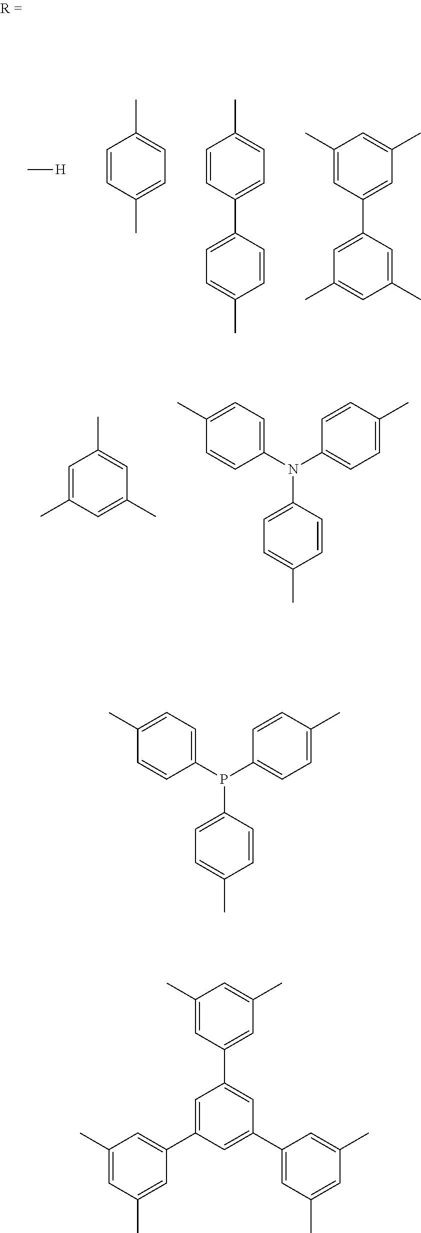

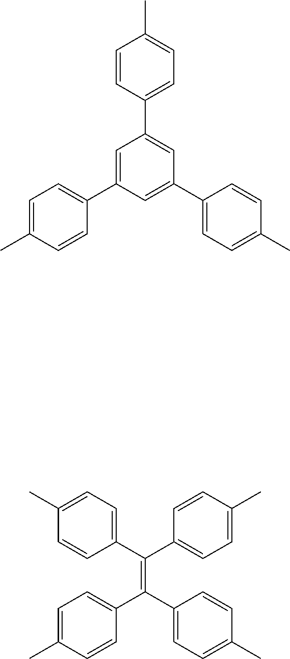

2. The carbazole phosphazene based polymer according to claim 1, wherein the carbazole phosphazene based polymer have a BET specific surface area of 250-2200 m²/g and a pore size of 0-30 nm.

3. The carbazole phosphazene based polymer according to claim 1, wherein the carbazole phosphazene based polymer is represented by the following formula: 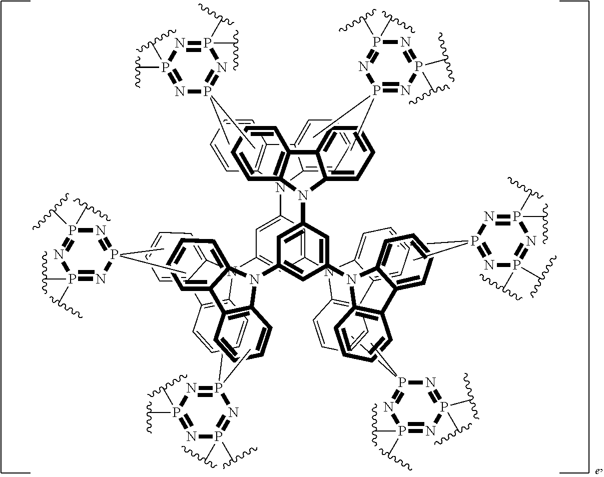
wherein e is an integer between 1000 and 50000, representing a number of third repeating units.

4. A method of a synthesis of the carbazole phosphazene-based polymer of claim 1, comprising: dissolving and mixing 1,3,5-tri(9H-carbazol-9-yl)benzene monomer with hexachlorocyclotrifosphazene monomer in dichlorobenzene and performing a polymerisation reaction catalysed by AlCl₃ or FeCl₃.

5. The method of the synthesis of the carbazole phosphazene based polymer according to claim 4, wherein the method comprises the following steps:
a) mixing 1,2-dichlorobenzene and anhydrous AlCl₃ or anhydrous FeCl₃ to obtain a first solution,
b) dissolving hexachlorocyclotriphosphazene in 1,2-dichlorobenzene to obtain a second solution,
c) mixing the first solution prepared in step (a) and the second solution prepared in step (b) to obtain a third solution,
d) dissolving 1,3,5-tri(9H-carbazol-9-yl)benzene in 1,2-dichlorobenzene to obtain a fourth solution,
e) mixing the fourth solution prepared in step (d) with the third solution obtained in step (c) to obtain a resulting mixture,
f) heating and allowing the resulting mixture to stand at a temperature,
g) cooling the resulting mixture, followed by performing a filtration on the resulting mixture to obtain a first filtered solid,
h) washing the first filtered solid with acid, water, and alcohol to obtain a washed solid,
i) soaking the washed solid in alcohol,
j) performing a filtration on the washed solid soaked in alcohol to separate a solid from a liquid to obtain a second filtered solid,
k) purifying the second filtered solid by soxhlet extractions with alcohol, tetrahydrofuran, and acetone to obtain a purified solid,
l) drying the purified solid.

6. The method of the synthesis of the carbazole phosphazene based polymer according to claim 5, wherein a HCl solution is configured as the acid and methanol is configured as the alcohol.

7. A method for recycling valuable metal elements from a metal solution containing the valuable metal elements, comprising the following steps:
a) adding the carbazole phosphazene based polymer according to claim 1 to the metal solution containing the valuable metal elements and allowing the valuable metal elements to adsorb onto the carbazole phosphazene based polymer,
b) performing a desorption and a recovery of the valuable metal elements adsorbed onto the carbazole phosphazene based polymer.

8. The method for recycling the valuable metal elements from the metal solution containing the valuable metal elements according to claim 7, wherein the valuable metal elements are selected from one or more of Au, Pd, Ag, Zr, Pt, Mo, Sc, Re, and Ti.

9. The method for recycling the valuable metal elements from the metal solution containing the valuable metal elements according to claim 7, further comprising adjusting a pH value of the metal solution containing the valuable metal elements to be within a range of 1-10.

10. The method for recycling the valuable metal elements from the metal solution containing the valuable metal elements according to claim 7, further comprising adjusting a pH of the metal solution containing the valuable metal elements based on a valuable metal element; wherein the pH of the metal solution containing the valuable metal elements is adjusted to 7 when the valuable metal element is palladium (Pd), the pH of the metal solution containing the valuable metal elements is adjusted to 4 when the valuable metal element is platinum (Pt), the pH of the metal solution containing the valuable metal elements is adjusted to 2 when the valuable metal element is gold (Au), and the pH of the metal solution containing the valuable metal elements is adjusted to 2 when the valuable metal element is silver (Ag).

11. A method for a recovery of precious metal elements adsorbed by a carbazole phosphazene based polymer, comprising the following steps:
a) adding the carbazole phosphazene based polymer according to claim 1 to a solution containing the precious metal elements,
b) mixing a solution obtained in step a),
c) filtering a precious metal element-adsorbed carbazole phosphazene based polymer,
d) washing a filtered precious metal element-adsorbed carbazole phosphazene based polymer,
e) drying a washed precious metal element-adsorbed carbazole phosphazene based polymer,
f) mixing a dried precious metal element-adsorbed carbazole phosphazene based polymer with an acidic solution,
g) filtering solution-polymer mixtures,
h) calculating a desorption efficiency.

12. The method for the recovery of the precious metal elements adsorbed by the carbazole phosphazene based polymer according to claim 11, wherein the acidic solution used in step f) is a mixture of
5% HNO₃;
10% HNO₃;
30% HNO₃;
0.05 M thiourea/0.05 M H₂SO₄;
18% HNO₃/2% HCl;
3% HNO₃/9% HCl;
0.1 M thiourea/0.1 M H₂SO₄;
0.1 M tiyoüre/1 M HCl/1 M HNO₃;
0.5 M tiyoüre/1 M HCl/1 M HNO₃;
1 M thiourea/1 M HCl/1 M HNO₃ 0.1 M thiourea/1 M HCl/1 M HNO₃.

13. The method for the recovery of the precious metal elements adsorbed by the carbazole phosphazene based polymer according to claim 11, wherein the mixing process in step f) is carried out for 1-86 hours.

14. The method for the recovery of the precious metal elements adsorbed by the carbazole phosphazene based polymer according to claim 11, wherein in step f), a 0.1 M thiourea/1 M HCl/1 M HNO₃ solution is used, and the dried precious metal element-adsorbed carbazole phosphazene based polymer and the 0.1 M thiourea/1 M HCl/1 M HNO₃ solution are mixed at 60° C. with an agitation at 120 rpm for 72 hours.

15. A method for a recovery of precious metal elements from electronic waste materials, comprising the following steps:
a) removing a coating layer from an electronic waste product,
b) immersing the electronic waste product with a removed coating layer into a first acidic solution at room temperature or below, allowing metals on the electronic waste product with the removed coating layer to enter the first acidic solution to obtain a first metal leachate solution, and filtering the first metal leachate solution to obtain filtered parts,
c) immersing the filtered parts into a second acidic solution at room temperature or below after a first leaching process to allow remaining precious metal elements from the first leaching process to enter the second acidic solution to obtain a second metal leachate solution, and filtering the second metal leachate solution to obtain a solution,
d) adding the carbazole phosphazene based polymer according to claim 1 to the solution.

16. The method for the recovery of the precious metal elements from the electronic waste materials according to claim 15, wherein a molar concentration of the first acidic solution used in step b) is lower than a molar concentration of the second acidic solution used in step c).

17. The method for the recovery of the precious metal elements from the electronic waste materials according to claim 15, wherein the first acidic solution used in step b) is an HCl solution, an HNO₃ solution, or a mixture of the HCl solution and the HNO₃ solution.

18. The method for the recovery of the precious metal elements from the electronic waste materials according to claim 15, wherein a molar concentration of the first acidic solution used in step b) is between 0.5-5 M.

19. The method for the recovery of the precious metal elements from the electronic waste materials according to claim 15, wherein the first acidic solution used in step b) is a 5 M molar concentration HCl solution.

20. The method for the recovery of the precious metal elements from the electronic waste materials according to claim 15, wherein a molar concentration of the second acidic solution used in step c) is between 5-12 M.

21. The method for the recovery of the precious metal elements from the electronic waste materials according to claim 15, wherein the second acidic solution used in step c) comprises a 12 M molar concentration of HCl.

22. The method for the recovery of the precious metal elements from the electronic waste materials according to claim 15, further comprising the following steps:
a) removing a coating layer of first electronic waste materials with a first basic solution,
b) washing removed electronic waste materials with water,
c) immersing washed electronic waste materials into a first acidic solution containing an HCl solution with a concentration of 0.5-5 M, an HNO₃ solution, or a mixture of the HCl solution with the concentration of 0.5-5 M and the HNO₃ solution,
d) removing the washed electronic waste materials from the first acidic solution containing the HCl solution and filtering the first acidic solution containing the HCl solution to obtain a first filtered solution,
e) adjusting a pH of the first filtered solution with a second basic solution and first deionized water to obtain a first adjusted filtered solution,
f) conducting an ICP-MS measurement on the first adjusted filtered solution,
g) immersing second electronic waste materials into a second acidic solution containing an HCl solution with a concentration of 5-12 M, an HNO₃ solution, or a mixture of the HCl solution with the concentration of 5-12 M and the HNO₃ solution,
h) removing the second electronic waste materials from the second acidic solution containing the HCl solution and filtering the second acidic solution containing HCl solution to obtain a second filtered solution,
i) adjusting a pH of the second filtered solution with a third basic solution and second deionized water to obtain a second adjusted filtered solution,
j) conducting the ICP-MS measurement on the second adjusted filtered solution,
k) adding the carbazole phosphazene based polymer to the second adjusted filtered solution,
l) mixing the second adjusted filtered solution and the carbazole phosphazene based polymer,
m) filtering the second adjusted filtered solution, separating from the carbazole phosphazene based polymer, and
n) measuring a remaining metal ion concentration in the second adjusted filtered solution using the ICP-MS measurement.

23. The method for the recovery of the precious metal elements from the electronic waste materials according to claim 22, wherein the pH in steps e) and i) is adjusted to be between 2-9.

24. The method for the recovery of the precious metal elements from the electronic waste materials according to claim 22, wherein the pH in steps e) and i) is adjusted to be 2.

25. The method for the recovery of the precious metal elements from the electronic waste materials according to claim 15, wherein the precious metal elements are one, several, or all of Au, Pd, Ag, Zr, Pt, Mo, Sc, Re, and Ti.
